(19) United States
(12) Patent Application Publication
(10) Pub. No.: US 2024/0293747 A1
(43) Pub. Date: Sep. 5, 2024

(54) Virtual Character Control Method and Apparatus, Storage Medium, and Electronic Device

(71) Applicant: Tencent Technology (Shenzhen) Company Limited, Shenzhen (CN)

(72) Inventors: Yingting Zhu, Shenzhen (CN); Fudong Liu, Shenzhen (CN)

(21) Appl. No.: 18/664,726

(22) Filed: May 15, 2024

Related U.S. Application Data
(63) Continuation of application No. PCT/CN2023/097314, filed on May 31, 2023.

(30) Foreign Application Priority Data
Jul. 28, 2022 (CN) 202210904336.5

(51) Int. Cl. A63F 13/56; A63F 13/52

(52) U.S. Cl. CPC A63F 13/56; A63F 13/52

(57) ABSTRACT

This application discloses a virtual character control method and apparatus, a storage medium, and an electronic device. The method includes: displaying, in response to a second virtual character being located in a first virtual region of a group of virtual regions, a first virtual item in an open state, a first virtual character located on the first virtual item, and a group of virtual items that the first virtual character has not passed; and displaying, in response to the second virtual character moving from the first virtual region to a second virtual region in the group of virtual regions, virtual items of a second type in the group of virtual items being in the open state, and virtual items of a second remaining type in the group of virtual items being in a closed state. The second remaining type is a type other than the second type in the types to which the group of virtual items belongs. According to this application, the technical problem of lack of interaction between players in games is solved.

### RELATED APPLICATION

This application claims priority to PCT application PCT/CN2023/097314, filed May 31, 2023, which in turn claims priority to Chinese Patent Application No. 202210904336.5, filed with the Chinese Patent Office on Jul. 28, 2022, each entitled “VIRTUAL CHARACTER CONTROL METHOD AND APPARATUS, STORAGE MEDIUM, AND ELECTRONIC DEVICE”, and each of which is incorporated herein by reference in its entirety.

### FIELD OF THE TECHNOLOGY

This application relates to the field of computer technologies, and in particular, to a virtual character control method and apparatus, a storage medium, and an electronic device.

### BACKGROUND OF THE DISCLOSURE

Interaction between players in games is an important part of the games. The interaction can enhance the game experience of the players.

Known interaction provided in games includes voice interaction or interaction on a chat page, which is more suitable for interaction between friends or acquaintances. However, there is less interaction between unfamiliar players who participate in a same game for the first time, and interaction performance is poor, which results in a poor game experience for the players.

### SUMMARY

Aspects herein provide an improved manner for unfamiliar players to interact with each other in a game. Aspects of this application provide a virtual character control method and apparatus, a storage medium, and an electronic device to solve at least the technical problem of lack of interaction between players in games, especially a lack of interaction between unfamiliar players, to improve interaction performance of the games, and improve the game experience of the players.

According to one aspect, a virtual character control method is provided, the method being performed by an electronic device, and the method including: displaying, in response to a second virtual character being located in a first virtual region of a group of virtual regions, a first virtual item in an open state, a first virtual character located on the first virtual item, and a group of virtual items that the first virtual character has not passed, where each virtual region in the group of virtual regions is used for controlling a type of virtual items to be in the open state, and in response to the second virtual character being located in the first virtual region, virtual items of a first type in the group of virtual items are in the open state, and virtual items of a first remaining type in the group of virtual items are in a closed state, the first remaining type being a type other than the first type in types to which the group of virtual items belongs; and displaying, in response to the second virtual character moving from the first virtual region to a second virtual region in the group of virtual regions, virtual items of a second type in the group of virtual items being in the open state, and displaying virtual items of a second remaining type in the group of virtual items being in the closed state, where the second remaining type is a type other than the second type in the types to which the group of virtual items belongs, the virtual items in the open state are allowed to be passed by the first virtual character, and the virtual items in the closed state are prohibited from being passed by the first virtual character.

According to another aspect, a virtual character control method is further provided, the method being performed by an electronic device, and the method including: displaying a first virtual character located on a first virtual item and a group of virtual items that the first virtual character and a second virtual character have not passed; controlling, in response to a jump triggering operation on the first virtual character, the first virtual character to jump a target distance; and in a case that the first virtual character is located on a second virtual item in the group of virtual items after jumping the target distance and a first virtual skill is in a state of being allowed to be released, releasing, in response to a release operation performed on the first virtual skill, the first virtual skill to move the second virtual character onto the second virtual item.

According to another aspect, a virtual character control method is further provided, the method being performed by an electronic device, and the method including: displaying a second virtual character located on a third virtual item and a group of virtual items that the second virtual character and a first virtual character have not passed; and in a case that the first virtual character is not located on any virtual item in the group of virtual items after jumping a target distance and a second virtual skill is in a state of being allowed to be released, releasing, in response to a release operation performed on the second virtual skill, the second virtual skill to move the first virtual character onto the third virtual item.

According to another aspect, a virtual character control apparatus is further provided, the apparatus being deployed on an electronic device, and the apparatus including: a first display module configured to display, in response to a second virtual character being located in a first virtual region of a group of virtual regions, a first virtual item in an open state, a first virtual character located on the first virtual item, and a group of virtual items that the first virtual character has not passed, where each virtual region in the group of virtual regions is used for controlling a type of virtual items to be in the open state, and in response to the second virtual character being located in the first virtual region, virtual items of a first type in the group of virtual items are in the open state, and virtual items of a first remaining type in the group of virtual items are in a closed state, the first remaining type being a type other than the first type in types to which the group of virtual items belongs; and a second display module configured to display, in response to the second virtual character moving from the first virtual region to a second virtual region in the group of virtual regions, virtual items of a second type in the group of virtual items being in the open state, and display virtual items of a second remaining type in the group of virtual items being in the closed state, where the second remaining type is a type other than the second type in the types to which the group of virtual items belongs, the virtual items in the open state are allowed to be passed by the first virtual character, and the virtual items in the closed state are prohibited from being passed by the first virtual character.

According to another aspect, a virtual character control apparatus is further provided, the apparatus being deployed on an electronic device, and the apparatus including: a third display module configured to display a first virtual character located on a first virtual item and a group of virtual items that the first virtual character and a second virtual character have not passed; a control module configured to control, in response to a jump triggering operation on the first virtual character, the first virtual character to jump a target distance; and a first response module configured to, in a case that the first virtual character is located on a second virtual item in the group of virtual items after jumping the target distance and a first virtual skill is in a state of being allowed to be released, release, in response to a release operation performed on the first virtual skill, the first virtual skill to move the second virtual character onto the second virtual item.

According to another aspect, a virtual character control apparatus is further provided, the apparatus being deployed on an electronic device, and the apparatus including: a fourth display module configured to display a second virtual character located on a third virtual item and a group of virtual items that the second virtual character and a first virtual character have not passed; and
a second response module configured to, in a case that the first virtual character is not located on any virtual item in the group of virtual items after jumping a target distance and a second virtual skill is in a state of being allowed to be released, release, in response to a release operation performed on the second virtual skill, the second virtual skill to move the first virtual character onto the third virtual item.

According to still another aspect, a computer-readable storage medium is further provided, the computer-readable storage medium including a stored computer program, where the computer program, when run on an electronic device, causing the electronic device to perform the above virtual character control method.

According to yet another aspect, a computer program product is provided, the computer program product including a computer program, and the computer program being stored in a computer-readable storage medium. A processor of an electronic device reads the computer program from the computer-readable storage medium. The processor executes the computer program to cause the electronic device to perform the virtual character control method as described above.

According to a further aspect, an electronic device is further provided, including a memory and a processor, the memory storing a computer program, and the processor being configured to perform the above virtual character control method through the computer program.

Through cooperation between the first virtual character and the second virtual character, the second virtual character moves from the group of virtual regions to control the corresponding virtual items to open, and the first virtual character may jump onto the virtual items in the open state. Specifically, when the second virtual character is located in the first virtual region, the virtual items of the first type are opened, and the first virtual character is located on the first virtual item of the first type. When the second virtual character moves from the first virtual region to the second virtual region, the virtual items of the second type are opened. In this way, the first virtual character can jump onto the virtual items of the second type. Tacit cooperation between the first virtual character and the second virtual character in the above process achieves a purpose of increasing the interaction between the first virtual character and the second virtual character, thereby achieving the technical effect of increasing interaction between players, especially providing unfamiliar players with simple interaction that is conducive to social ice-breaking, which solves the technical problem of lack of interaction between players in games, especially lack of interaction between unfamiliar players, improve interaction performance of the games, and improve game experience of the players.

### BRIEF DESCRIPTION OF THE DRAWINGS

The accompanying drawings described herein are used to provide a further understanding of this application, and form a part of this application. Illustrative aspects of this application and descriptions thereof are used to explain this application, and do not constitute any inappropriate limitation on this application. In the accompanying drawings,

FIG. 1 is a schematic diagram of an application environment of an optional virtual character control method according to one or more illustrative aspects described herein.

FIG. 2 is a schematic flowchart of an optional virtual character control method according to one or more illustrative aspects described herein.

FIG. 3 is a schematic diagram of an optional game screen according to one or more illustrative aspects described herein.

FIG. 4 is a schematic diagram of another optional game screen according to one or more illustrative aspects described herein.

FIG. 5 is a schematic diagram of yet another optional game screen according to one or more illustrative aspects described herein.

FIG. 6 is a schematic diagram of yet another optional game screen according to one or more illustrative aspects described herein.

FIG. 7 is a schematic diagram of yet another optional game screen according to one or more illustrative aspects described herein.

FIG. 8 is a schematic diagram of yet another optional game screen according to one or more illustrative aspects described herein.

FIG. 9 is a schematic diagram of yet another optional game screen according to one or more illustrative aspects described herein.

FIG. 10 is a schematic diagram of yet another optional game screen according to one or more illustrative aspects described herein.

FIG. 11 is a schematic diagram of yet another optional game screen according to one or more illustrative aspects described herein.

FIG. 12 is a schematic diagram of yet another optional game screen according to one or more illustrative aspects described herein.

FIG. 13 is a schematic diagram of yet another optional game screen according to one or more illustrative aspects described herein.

FIG. 14 is a schematic diagram of yet another optional game screen according to one or more illustrative aspects described herein.

FIG. 15 is a schematic flowchart of another optional virtual character control method according to one or more illustrative aspects described herein.

FIG. 16 is a schematic diagram of yet another optional game screen according to one or more illustrative aspects described herein.

FIG. 17 is a schematic diagram of yet another optional game screen according to one or more illustrative aspects described herein.

FIG. 18 is a schematic diagram of yet another optional game screen according to one or more illustrative aspects described herein.

FIG. 19 is a schematic diagram of yet another optional game screen according to one or more illustrative aspects described herein.

FIG. 20 is a schematic diagram of yet another optional game screen according to one or more illustrative aspects described herein.

FIG. 21 is a schematic flowchart of yet another optional virtual character control method according to one or more illustrative aspects described herein.

FIG. 22 is a schematic diagram of yet another optional game screen according to one or more illustrative aspects described herein.

FIG. 23 is a schematic diagram of yet another optional game screen according to one or more illustrative aspects described herein.

FIG. 24 is a schematic diagram of yet another optional game screen according to one or more illustrative aspects described herein.

FIG. 25 is a schematic diagram of yet another optional game screen according to one or more illustrative aspects described herein.

FIG. 26 is a schematic diagram of an optional game description according to one or more illustrative aspects described herein.

FIG. 27 is a schematic diagram of yet another optional game screen according to one or more illustrative aspects described herein.

FIG. 28 is a schematic diagram of yet another optional game screen according to one or more illustrative aspects described herein.

FIG. 29 is a schematic diagram of yet another optional game screen according to one or more illustrative aspects described herein.

FIG. 30 is a schematic structural diagram of an optional virtual character control apparatus according to one or more illustrative aspects described herein.

FIG. 31 is a structural block diagram of a computer system of an optional electronic device according to one or more illustrative aspects described herein.

FIG. 32 is a schematic structural diagram of an optional electronic device according to one or more illustrative aspects described herein.

### DESCRIPTION OF EMBODIMENTS

To make a person skilled in the art understand solutions of this application better, the following describes the technical solutions in the aspects of this application with reference to the accompanying drawings in the aspects of this application. The described aspects are merely some but not all of the aspects of this application. All other aspects obtained by a person of ordinary skill in the art based on the aspects of this application without creative efforts shall fall within the protection scope of this application.

In the specification, claims, and accompanying drawings of this application, the terms “first”, “second”, and so on are intended to distinguish similar objects but do not necessarily indicate a specific order or sequence. It is to be understood that the data so used are interchangeable under appropriate circumstances so that the aspects of this application described herein can be implemented in orders except the order illustrated or described herein. Moreover, the terms “comprise/include”, “have” and any other variants mean to cover the non-exclusive inclusion, for example, a process, method, system, product, or device that includes a list of steps or units is not necessarily limited to those units, but may include other units not expressly listed or inherent to such a process, method, system, product, or device.

First, some nouns or terms appearing in the description of the aspects of this application are suitable for the following explanations:

A cross-server social map is a map on which various check-in gameplay points are available for players to play.

A charge jump is a name of a jump skill. After charge is long pressed, a long-distance jump may be performed according to a charge duration. A longer charge leads to a farther jump distance.

Carry is a name of a game skill. Two virtual characters are connected by a connecting line, through which one teammate may be pulled to the other's side within a limited distance range. The connecting line may be used for rescuing a teammate falling into water.

In a fall-into-water state, when a virtual character is in the water for more than a certain duration (e.g., 5 s or 6 s, which may be set according to an actual situation), the virtual character may be teleported back to a starting point of a current stage.

A passing duration is a total duration from starting of a game to completion of the game.

A score board is an object at the end of a scene. After the score board is approached, information of two players with the shortest passing duration for the gameplay in this server can be viewed.

This application is described below with reference to aspects:

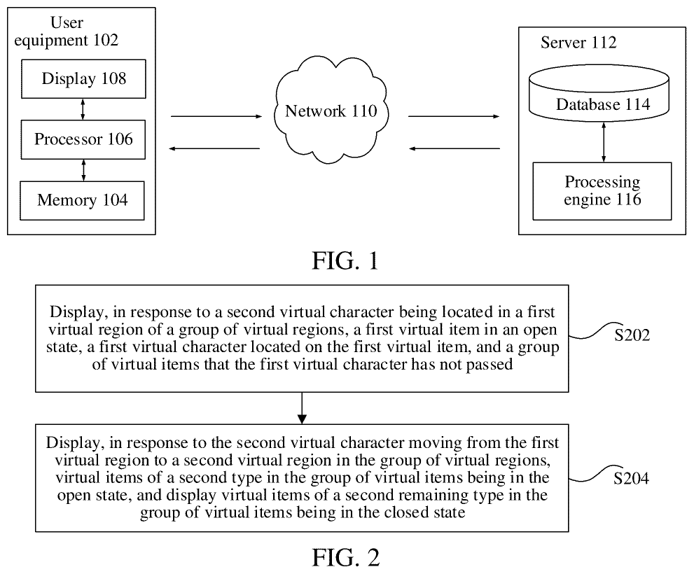

According to one aspect, a virtual character control method is provided. As an optional implementation, the above virtual character control method may be applied to, but is not limited to, an environment shown in FIG. 1. The environment may include, but is not limited to, a user equipment 102, a network 110, and a server 112. The user equipment 102 may include, but is not limited to, a display 108, a processor 106, and a memory 104. The server 112 includes a database 114 and a processing engine 116.

In a possible implementation, the above user equipment may be a terminal device provided with a client, which may include, but is not limited to, at least one of the following: a mobile phone (such as an Android phone or an iOS phone), a notebook computer, a tablet computer, a palmtop computer, mobile Internet devices (MID), a PAD, a desktop computer, and a smart TV. The client may be a game client, a video client, an instant messaging client, a browser client, an education client, or the like. The memory 104 is configured to store game data, including, but not limited to, game data such as a first virtual character, a second virtual character, virtual regions, and virtual items. The processor 106 is configured to process the game data, including, but not limited to, responding to player operations in virtual games. The display 108 is configured to display game screens, including, but not limited to, displaying a first virtual item in an open state, a first virtual character located on the first virtual item, and a group of virtual items that the first virtual character has not passed, display virtual items of a second type in the group of virtual items being in the open state, and displaying virtual items of a second remaining type in the group of virtual items being in a closed state.

The network 110 may include, but is not limited to, a wired network, and a wireless network. The wired network includes: a local area network, a metropolitan area network, and a wide area network. The wireless network includes Bluetooth, WIFI, and other networks that implement wireless communication.

The server 112 may be a single server, a server cluster including a plurality of servers, or a cloud server. The database 114 is configured to store the game data, including, but not limited to, the game data such as the first virtual character, the second virtual character, the virtual regions, and the virtual items. The processing engine 116 is configured to process the game data, including, but not limited to, controlling opening and closing of the virtual items.

As an optional implementation, as shown in FIG. 2, the above virtual character control method includes the following steps:

S202: Display, in response to a second virtual character being located in a first virtual region of a group of virtual regions, a first virtual item in an open state, a first virtual character located on the first virtual item, and a group of virtual items that the first virtual character has not passed, where each virtual region in the group of virtual regions is used for controlling a type of virtual items to be in the open state, and in response to the second virtual character being located in the first virtual region, virtual items of a first type in the group of virtual items are in the open state, and virtual items of a first remaining type in the group of virtual items are in a closed state, the first remaining type being a type other than the first type in types to which the group of virtual items belongs.

The first virtual character and the second virtual character may be game characters controlled by different players. The first virtual character and the second virtual character need to cooperate to complete a game task.

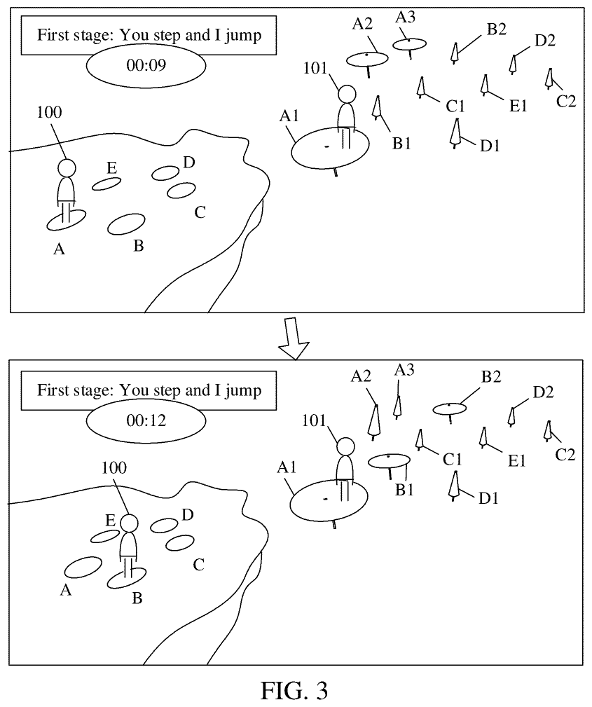

In a game screen diagram shown in FIG. 3, a second virtual character 100 shown in the figure is located in a virtual region A. In this case, the virtual region A may be used as a first virtual region. The group of virtual regions includes, but is not limited to, virtual regions A, B, C, D, and E shown in the figure. A first virtual character 101 shown in the figure is located on a virtual item A1. In this case, the virtual item A1 may be used as a first virtual item. The group of virtual items that the first virtual character has not passed includes A2, A3, B1, B2, C1, C2, and E1 (FIG. 3 is only used as an embodiment to illustrate this application, and a quantity of a specific group of virtual items may be determined according to an actual situation) shown in the figure. The virtual regions A, B, C, D, and E shown in the figure are respectively used for controlling a type of virtual items to be in an open state. As shown in the figure, A1, A2, and A3 are virtual items of a same type, B1 and B2 are virtual items of a same type, C1 and C2 are virtual items of a same type, and E1 is a virtual item of one type. The virtual items of the same type may have a same color, a same pattern, a same number, or the like. A specific type setting manner may be determined according to an actual situation.

For example, the virtual items of the same type are in a same color. Assuming that A1, A2, and A3 are blue virtual items, a color of the virtual region A shown in the figure may also be set to blue. The virtual region A is used for controlling the virtual items A1, A2, and A3 of the same type to be in an open state. Similarly, assuming that B1 and B2 are yellow virtual items, a color of the virtual region B shown in the figure may also be set to yellow. The virtual region B is used for controlling the virtual items B1 and B2 of the same type to be in the open state, and so on (since only black and white colors are allowed in the illustration, blue and yellow are not shown in FIG. 3. However, in an actual game, blue and yellow may be used for distinguishing types of virtual items and controlling virtual regions of different types of virtual items).

As shown in FIG. 3, since the virtual region A is used for controlling the virtual items A1, A2, and A3 of the same type to be in the open state, when the second virtual character 100 is located in the virtual region A, the virtual items A1, A2, and A3 (i.e., the virtual items of the first type) shown in the figure are in the open state. The virtual items B1, B2, C1, C2, and E1 of the first remaining type are in the closed state. The first remaining type is a type other than the first type in types to which the group of virtual items belongs.

S204: Display, in response to the second virtual character moving from the first virtual region to a second virtual region in the group of virtual regions, virtual items of a second type in the group of virtual items being in the open state, and display virtual items of a second remaining type in the group of virtual items being in the closed state, where the second remaining type is a type other than the second type in the types to which the group of virtual items belongs, the virtual items in the open state are allowed to be passed (e.g., traversed) by the first virtual character, and the virtual items in the closed state are prohibited from being passed or traversed by the first virtual character.

As shown in FIG. 3, the second virtual character 100 moves from virtual region A to the virtual region B. In this case, the virtual region B may be used as the second virtual region. Since the virtual region B is used for controlling the virtual items B1 and B2 of the same type (the second type) to be in the open state. In the virtual items as shown in the figure, the virtual items B1 and B2 change to the open state, and the virtual items A2 and A3 change to the closed state, and the virtual items passed by the first virtual character remain in the open state. As shown in the figure, the virtual item A1 continues to remain in the open state. The virtual items in the open state are allowed to be passed by the first virtual character. That is, B1 and B2 shown in the figure are allowed to be passed by the first virtual character, while the virtual items in the closed state are prohibited from being passed by the first virtual character. As shown in the figure, A2, A3, C1, C2, and E1 are prohibited from being passed by the first virtual character.

As an optional implementation, the virtual region in the above aspects may be called a buff circle, and the above virtual items may be virtual floral umbrellas. A virtual character (the second virtual character) controlled by one player enters the buff circle and opens the virtual floral umbrella corresponding to a color of the buff circle. For example, the second virtual character enters the blue buff circle and opens the blue virtual floral umbrella. A virtual character (the first virtual character) controlled by the other player jumps on the opened virtual floral umbrella and is considered as passing when reaching a floral boat at an end point. At this stage, the two players may start a team voice/team chat for effective communication to achieve social ice-breaking.

In the above aspects, the method may be applied to the cross-server social page, which carries fun gameplay of a social ice-breaking function, is low in difficulty and high in fun and randomness, and has fun of repeated experience. The virtual character control method is integrated with scene objects, and virtual floral umbrellas dot the game screen, which is full of fun and interest. Moreover, the color of the virtual floral umbrella in each round may be randomized, and a score board object is disposed at the end of the scene. When the score board object is approached, information of two players with the shortest passing duration for the gameplay in this server can be viewed, which improves a sense of purpose for repeated experience.

In a possible implementation, the method further includes: displaying, in response to the second virtual character moving from the first virtual region to the second virtual region, the first virtual character on the first virtual item in the open state, where a type of the first virtual item is the first type, and the virtual items that the first virtual character has passed are all in the open state, or the virtual item that the first virtual character finally passes is in the open state; or controlling, in response to the second virtual character moving from the first virtual region to the second virtual region, the first virtual item to switch from the open state to the closed state, where the type of the first virtual item is the first type.

As an optional implementation, virtual items of a same type may have a same color, a same pattern, a same number, or the like. A specific type setting manner may be determined according to an actual situation. For example, the virtual items of the same type are in a same color. The first virtual item of the first type may be a virtual item in a same color, for example, a blue virtual item.

Taking a game screen shown in FIG. 3 as an example, the second virtual character moves from the virtual region A (the first virtual region) to the virtual region B (the second virtual region), the virtual item A1 (the first virtual item) is still in the open state, and the first virtual character is located on the virtual item A1.

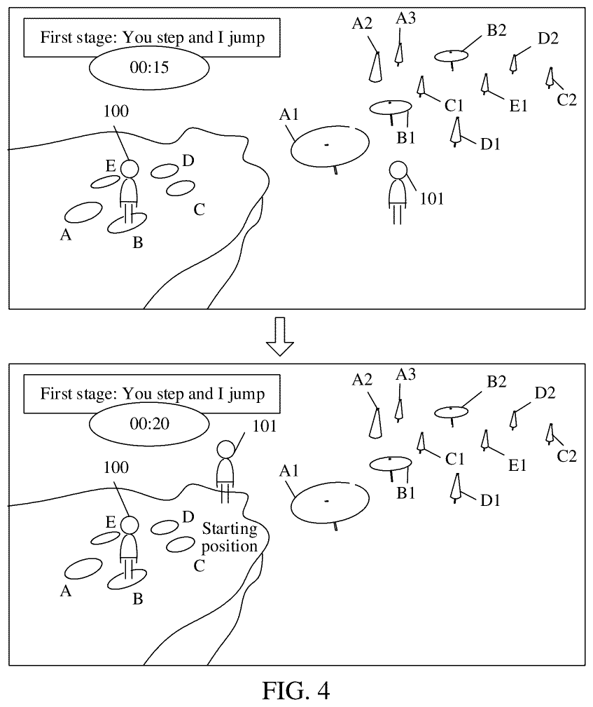

In an optional implementation, a virtual item passed (traversed) by the first virtual character remains in the open state. For example, the virtual item A1 shown in FIG. 3 is the virtual item that the first virtual character has passed and remains in the open state. In this way, if the first virtual character does not move to any virtual item (for example, falls into the sea, or falls to the ground) while moving between virtual items, the first virtual character returns to a starting position of the game and may move from the opened virtual item. As shown in FIG. 4, the first virtual character 101 falls to the ground from the virtual item A1. Since the virtual item A1 is the virtual item that the first virtual character has passed, the virtual item A1 remains in the open state, and the first virtual character returns to the starting position and may continue to move on the opened virtual item. In this way, the virtual item that has been opened before the falling to the ground does not need to be opened again through the second virtual character, which simplifies complexity of the game, improves game efficiency, and enhances game experience of the players.

In another optional implementation, the virtual item that the first virtual character finally passes (e.g., most recently traverses) remains in the open state. The above virtual item finally passed may be a virtual item on which the first virtual character is located before falling to the ground. The first virtual character 101 falls to the ground from the virtual item A1. Since the virtual item A1 is the virtual item on which the first virtual character is located before falling to the ground, the virtual item A1 remains in the open state. Different from the above aspects, the first virtual character returns to the virtual item before falling to the ground (the virtual item finally passed). In this way, the game continues on the virtual item before the falling to the ground (on the virtual item A1), which simplifies complexity of the game, improves game efficiency, and enhances game experience of the players.

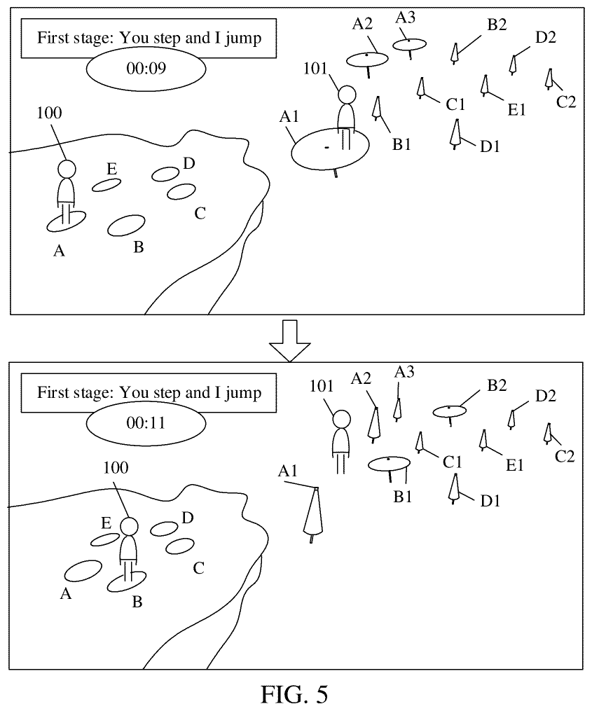

In still another optional implementation, taking FIG. 5 as an example, the second virtual character moves from the virtual region A (the first virtual region) to the virtual region B (the second virtual region). When the second virtual character is located in the second virtual region, the virtual items B1 and B2 are opened, and the virtual item A1 is closed at the same time. In this case, the first virtual character needs to move from the virtual item A1 to the virtual items B1 or B2 in time. Otherwise, the first virtual character may fall to the ground. This requires strict cooperation between the first virtual character and the second virtual character. In other words, the first virtual character needs to move from the virtual item A1 to the virtual item B1 or B2 while the second virtual character moves from the virtual region A to the virtual region B. This increases the complexity of the game and motivates the players to make a challenge.

In a possible implementation, the method further includes: during the switching of the first virtual item from the open state to the closed state, in a case that it is detected that a jump triggering operation is performed on the first virtual character, controlling, in response to the jump triggering operation, the first virtual character to jump away from the first virtual item, where the jump triggering operation is used for controlling the first virtual character to jump away from the first virtual item.

As an optional implementation, as shown in FIG. 5, the second virtual character moves from the virtual region A to the virtual region B, and the virtual item A1 switches from the open state to the closed state. During the switching of the virtual item A1 to the closed state, it is detected whether a player controlling the first virtual character performs a jump triggering operation on the first virtual character 101, and if yes, in response to the jump triggering operation, the first virtual character is controlled to perform a jumping action and leave the virtual item A1.

In a possible implementation, the method further includes: during the switching of the first virtual item from the open state to the closed state, in a case that it is not detected that the jump triggering operation is performed on the first virtual character, displaying the first virtual character falling from the first virtual item.

For example, if the first virtual character 101 has not performed the jumping action after the first virtual item A1 switches to the closed state, the first virtual character 101 falls from the first virtual item (for example, falls to the ground or falls into the sea) and needs to return to an initial position to restart the game.

In a possible implementation, the method further includes: in a case that the second virtual character is located in the second virtual region, the first virtual character is currently located on the first virtual item, and a type of a second virtual item allowed to be passed by the first virtual character and following the first virtual item is the second type, controlling, in response to the jump triggering operation performed on the first virtual character, the first virtual character to jump from the first virtual item to the second virtual item in the open state.

As an optional implementation, a virtual item whose distance from the first virtual character is less than or equal to a preset distance threshold (which may be set according to an actual situation, such as 0.5 m or 1 m) is a virtual item allowed to be passed by the first virtual character. One or more virtual items may be allowed to be passed by the first virtual character. In a case that a plurality of virtual items are allowed to be passed by the first virtual character, the plurality of virtual items allowed to be passed by the first virtual character may be virtual items of a same type or virtual items of different types.

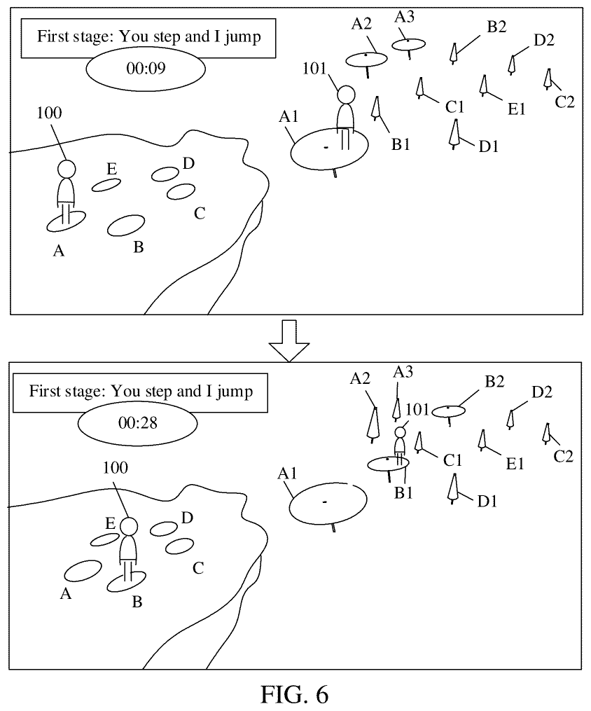

In an optional implementation, as shown in FIG. 6, when the second virtual character 100 is located in the virtual region A (the first virtual region), the first virtual character 101 is located on the virtual item A1 (the first virtual item). In this case, it is assumed that virtual items whose distances from the first virtual character 101 are less than or equal to the preset distance threshold include the virtual items A2, B1, and D1 (the virtual items allowed to be passed by the first virtual character include the virtual items A2, B1, and D1). When the second virtual character moves from the virtual region A to the virtual region B (the second virtual item), the virtual items A2 and A3 are closed, and B1 and B2 are opened. Since the virtual item B1 of the second type (the second virtual item) is a virtual item allowed to be passed by the first virtual character, the player may cause the first virtual character to perform a jumping action to jump from the virtual item A1 to the virtual item B1.

In a possible implementation, after the displaying a first virtual item in an open state, a first virtual character located on the first virtual item, and a group of virtual items that the first virtual character has not passed, the method further includes: in a case that the second virtual character is located in the first virtual region, the first virtual character is currently located on the first virtual item, and a type of a third virtual item allowed to be passed by the first virtual character and following the first virtual item is the first type, controlling, in response to the jump triggering operation performed on the first virtual character, the first virtual character to jump from the first virtual item to the third virtual item in the open state.

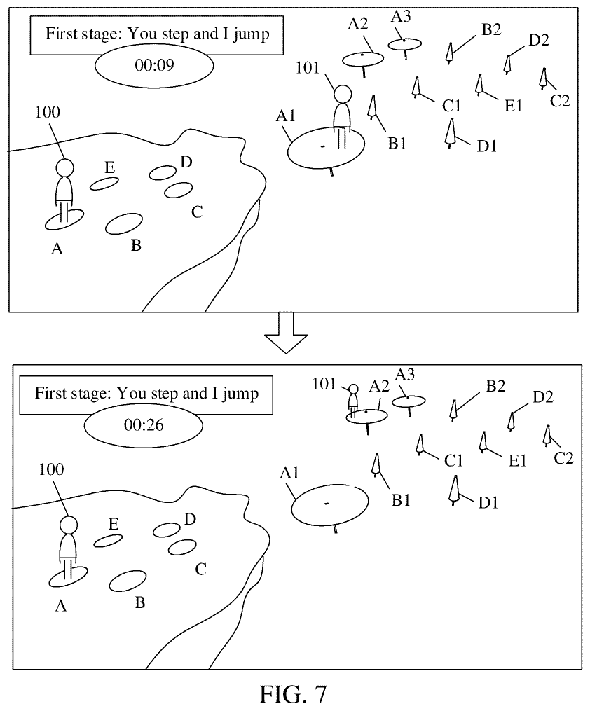

As an optional implementation, as shown in FIG. 7, when the second virtual character is located in the virtual region A (the first virtual region), the virtual items A1, A2, and A3 are in the open state, and the first virtual character is located on the virtual item AL. In this case, it is assumed that virtual items whose distances from the first virtual character 101 are less than or equal to the preset distance threshold include the virtual items A2, B1, and D1 (the virtual items allowed to be passed by the first virtual character include the virtual items A2, B1, and D1). Since the virtual item A2 of the first type (the third virtual item) is a virtual item allowed to be passed by the first virtual character, the player may touch the first virtual character to perform a jumping action to jump from the virtual item A1 to the virtual item A2.

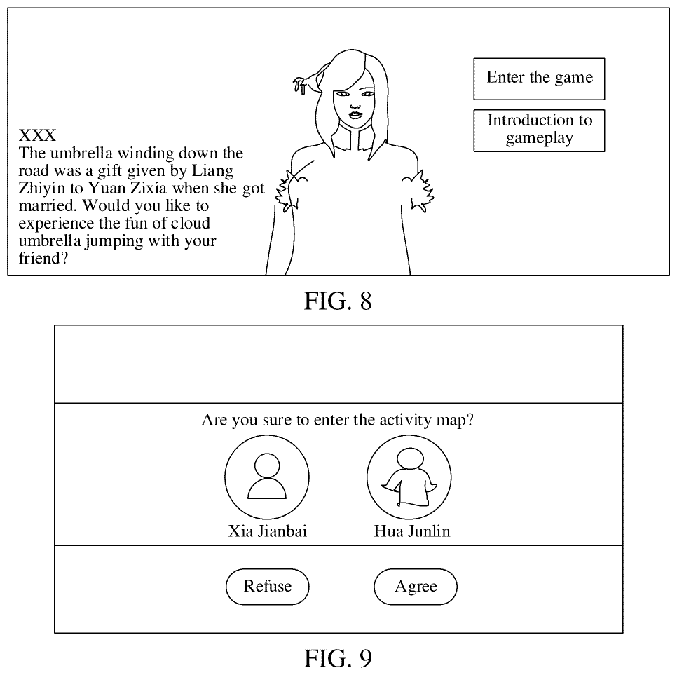

As an optional implementation, two players may team up to participate in the game, cross-server players may be supported to team up to participate, and the game is entered through a non-player character (NPC) dialog option. As shown in FIG. 8, the players may enter the game through this game interface.

When the game is entered as shown in FIG. 8, an interface pops up with the two players preparing. After confirming the preparation, the two players enter a plane to start a gameplay. As shown in FIG. 9, the players may choose to agree to or refuse/decline to team up with each other to enter the game on the game interface.

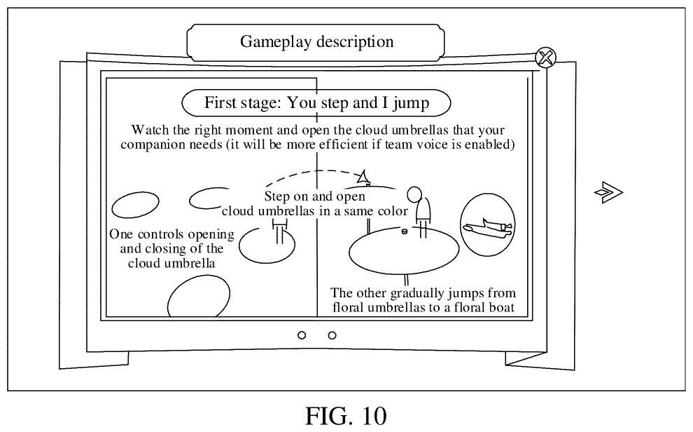

For the player entering the gameplay for the first time, a gameplay description interface pops up, and the player may switch pages to view a gameplay introduction. The player may talk to an NPC later and re-open and view the gameplay introduction. As shown in FIG. 10, the player may learn the gameplay on the interface.

In a possible implementation, the method further includes: displaying, when the first virtual character is located on the first virtual item in the open state, the second virtual character being located in the first virtual region in the group of virtual regions, and when the second virtual character is located in the first virtual region, the virtual items of the first type that the first virtual character has not passed are in the open state, and the virtual items of the first remaining type in the group of virtual items are in the closed state; and controlling, in response to a movement triggering operation performed on the second virtual character, the second virtual character to move from the first virtual region to the second virtual region, where, in a case that the second virtual character is located in the second virtual region, the virtual items of the second type are in the open state, and the virtual items of the second remaining type are in the closed state, where the virtual items in the open state are allowed to be passed by the first virtual character, and the virtual items in the closed state are prohibited from being passed by the first virtual character.

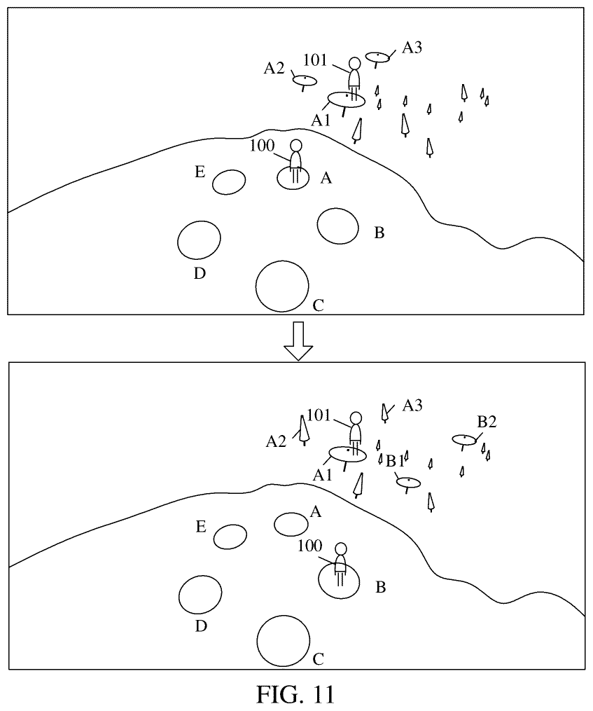

As an optional implementation, a game screen shown in FIG. 11 is displayed on a game screen of a player controlling the second virtual character. A group of virtual regions A, B, C, and D are displayed on the game screen. When the first virtual character is located on the virtual item A1 (the first virtual item) in the open state, the second virtual character is located in the virtual region A (the first virtual region). The player controlling the second virtual character may touch a movement triggering operation to trigger the second virtual character to move from the first virtual region to other virtual regions in the group of virtual regions, for example, move from the virtual region A to the virtual region B (the second virtual region). After the second virtual character moves from the virtual region A to the virtual region B, the second virtual region controls the virtual item of the second type to be in the open state. As shown in the figure, B1 and B2 are opened. In this way, the first virtual character can move from the first virtual item A1 to B1 or B2.

As an optional implementation, in the above aspects, the virtual items of the same type are in a same color. In this aspect, virtual items in a plurality of colors may be set (e.g., five colors, where the colors may be randomly set, such as blue, red, purple, pink, and yellow), and a virtual region controlling one type of virtual items may be in a same color as the virtual items of the type. For example, a blue virtual region is used for controlling blue virtual items. In each round of the game, the virtual items and the virtual regions may randomly change in color but may not change in position. After the game is entered, other skills of the virtual characters may be shielded, and the jump skill is retained.

In an optional implementation, that the second virtual character moves from the first virtual region to a second virtual region in the group of virtual regions includes: in response to the second virtual character receiving a notification message transmitted by the first virtual character, the second virtual character moving from the first virtual region to the second virtual region as instructed by the notification message, where the notification message is a voice message or a text message, and the notification message is used for instructing the second virtual character to move from the first virtual region to the second virtual region in the group of virtual regions.

As an optional implementation, the second virtual character steps on each virtual region in the group of virtual regions and opens virtual items of a corresponding type. The first virtual character jumps on the opened virtual items, the virtual items that the first virtual character has stepped on remain in the open state, and a player 1 controlling the second virtual character may be notified, through voice or typing of a player 2 controlling the first virtual character, of the virtual items that have not been stepped on. In this way, the player 1 can control the second virtual character to move to the corresponding virtual region. Voice communication is faster, increasing a speed at which the first virtual character jumps on the virtual items. The first virtual character is currently on the virtual item A1 (the first virtual item). In this case, the second virtual character is in the virtual region A (the first virtual region). In the group of virtual items that the first virtual character has not passed, the virtual items allowed to be passed by the first virtual character include: virtual items B1 and C1. In this case, the player 1 controlling the first virtual character may notify, through voice or text, the player 2 controlling the second virtual character that a next virtual item the first virtual character wants to pass is B1 or C1. Assuming that the next virtual item the first virtual character wants to pass is B1, the player 2 controlling the second virtual character, after receiving a notification message, may control the second virtual character to move from the virtual region A to the virtual region B (the second virtual region).

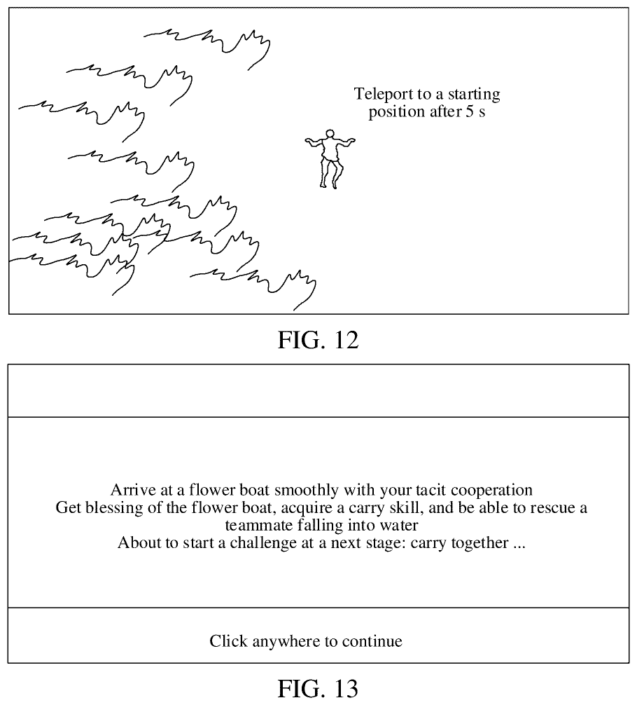

As an optional implementation, after the first virtual character falls from the virtual item for a certain duration (e.g., 5 s), the first virtual character is teleported to the starting position, and the game restarts. The second virtual character falls from a group of virtual regions (e.g., falls into the sea). The second virtual character is teleported to the starting position, and the game restarts. As shown in FIG. 12, the virtual character shown in the figure may be the first virtual character or the second virtual character. After the first virtual character or the second virtual character falls into the sea, the game screen shown in the figure is displayed to remind the player that the corresponding virtual character will return to the starting position.

As an optional implementation, when the first virtual character moves from a starting virtual item to an ending virtual item, the first virtual character and the second virtual character complete the round of the game. In this embodiment, a timing function is further provided to time the time it takes for the first virtual character and the second virtual character to complete the round of the game, and the timing may be displayed on the game screen. A group of virtual characters completing the round of the game with the least time wins.

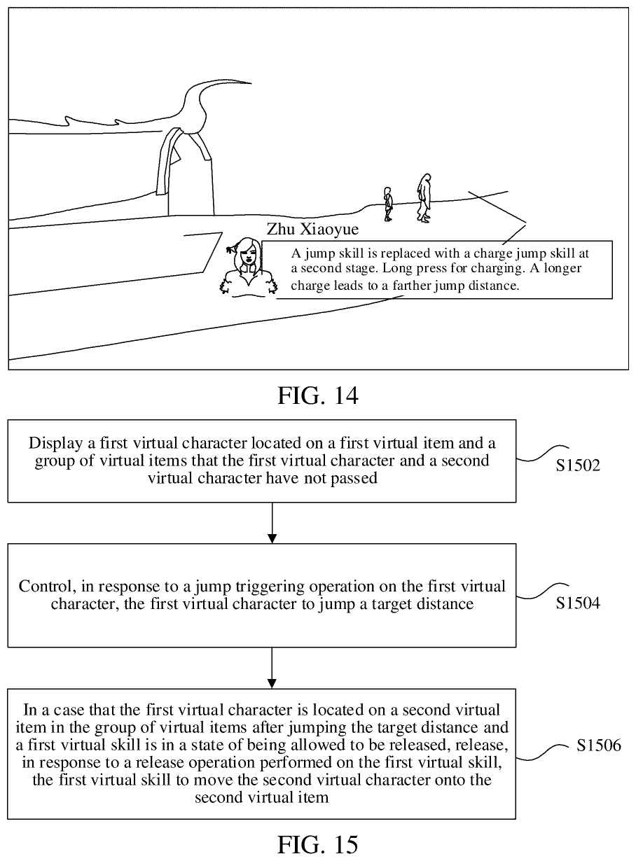

As an optional implementation, after the first virtual character and the second virtual character complete a round of the game, a first stage of the game is completed, a game screen as shown in FIG. 13 may be displayed, and a next stage (a second stage) of the game is started. FIG. 14 is a schematic diagram of a game screen entering the second stage.

According to another aspect of the aspects of this application, a virtual character control method is further provided. As shown in FIG. 15, the method includes the following steps:

S1502: Display a first virtual character located on a first virtual item and a group of virtual items that the first virtual character and a second virtual character have not passed.

S1504: Control, in response to a jump triggering operation on the first virtual character, the first virtual character to jump a target distance.

In a possible implementation, the jump triggering operation may be performed through a jump key. Generally, a player may be charged by touching and long-pressing the jump key to achieve a charge jump. When the player touches the jump key for a longer time, a charge duration for the jump triggering operation is longer. In this case, the charge is greater, and the jump distance is further. That is, the target distance is farther. In other words, the target distance is positively related to a charge duration of the jump triggering operation.

S1506: In a case that the first virtual character is located on a second virtual item in the group of virtual items after jumping the target distance and a first virtual skill is in a state of being allowed to be released, release, in response to a release operation performed on the first virtual skill, the first virtual skill to move the second virtual character onto the second virtual item.

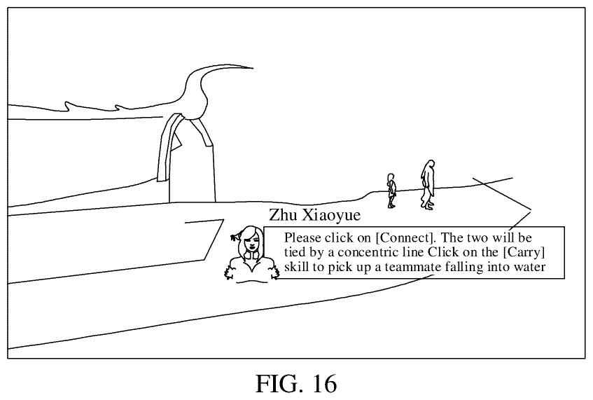

As an optional implementation, at the second stage of the game, the first virtual character and the second virtual character may be connected through a connecting line, and the first virtual character and the second virtual character connected have a “carry” skill. On a game interface shown in FIG. 16, a player may click on Connect to connect the first virtual character and the second virtual character by the connecting line, and click on the carry skill to lift up a teammate falling into the water.

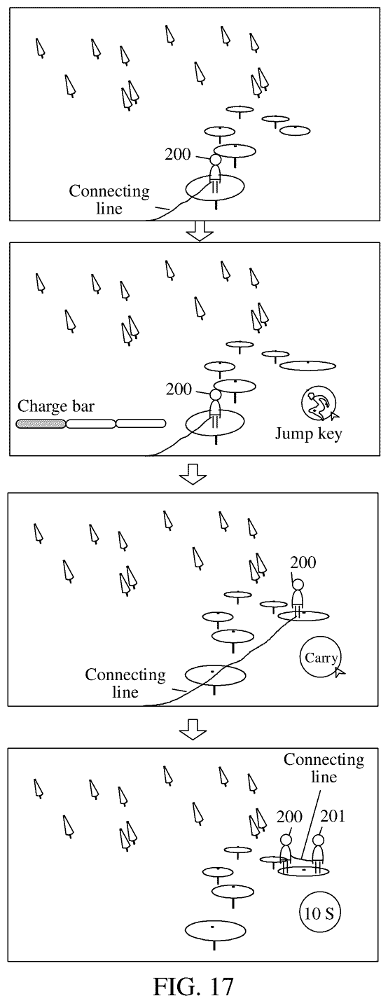

As an optional implementation, a game screen as shown in FIG. 17 may be a game screen of a player controlling the first virtual character, and a first virtual character 200 and virtual items that the first virtual character and the second virtual character have not passed are displayed on the game screen.

The player controlling the first virtual character may perform a touch operation on a jump key on the game screen. The jump key may be a virtual key or a physical key (e.g., a joystick). In the figure, the virtual key is taken as an example, and a charge jump may be realized through the virtual key. If the player touches the jump key for a longer time, the charge is greater, and the first virtual character jumps farther. As shown in the figure, a charge bar is displayed, and progress of the charge bar is proportional to a duration during which the jump key is touched. If the jump key is touched for a longer time, the progress of the charge bar is longer, and the first virtual character jumps farther. According to long press durations of the player, several (which may be determined according to an actual situation, e.g., 9) different jump distances may be set. The charge bar needs to be designed into three sections of colors to help the player to confirm a jump distance (one section is approximately a distance between virtual items). Each section includes three small intervals with an actual jump distance, on which small scales may be made.

It is assumed that, after the above charge jump is performed, a distance moved by the first virtual character is the target distance, and the first virtual character just jumps to the second virtual item. The above first virtual skill is the carry skill. If the carry skill between the first virtual character and the second virtual character is allowed to be released in this case, the carry skill is displayed on the game screen shown in FIG. 17. When the player touches the key, the carry skill is released, and a second virtual character 201 moves to the second virtual item.

As an optional implementation, in a “Carry Together” game at the second stage, both the first virtual character and the second virtual character acquire carry and charge jump skills. The two virtual characters need to cooperate with each other to jump on virtual items to reach an end point together and complete all challenges. At the stage, the two virtual characters need to jump together, and one player may use the carry skill within a limited time of 5 s to rescue the other player making a mistake, increasing interaction between the two players.

In a possible implementation, the method further includes: displaying, before the controlling the first virtual character to jump a target distance, a connecting line between the first virtual character and the second virtual character, where the connecting line is used for indicating that the second virtual character is allowed to move onto a virtual item, on which the first virtual character is currently located, by releasing the first virtual skill; and displaying, in a case that the first virtual character is located on the second virtual item after jumping the target distance and a distance between the first virtual character and the second virtual character is less than or equal to a preset distance threshold, the first virtual character located on the second virtual item, and displaying the connecting line between the first virtual character and the second virtual character.

As an optional implementation, two virtual characters may be accommodated on a virtual item, the virtual item may be located on the sea, a height of the virtual item from the screen may be higher than a jumping height, and the height of the virtual item from ground/sea level may be the same as a distance of the connecting line between the first virtual character and the second virtual character. The first virtual character or the second virtual character reaches the first virtual item and enters the game. The connecting line between the first virtual character and the second virtual character indicates that there is a carry skill (the first virtual skill) between the first virtual character and the second virtual character. When the first virtual character moves onto the second virtual item, the second virtual character may be directly moved to the second virtual item through the carry skill. Also, the virtual character falling can be pulled up by using the carry skill. The player may obtain the carry skill by clicking on the connecting line, may use the carry skill within a specified distance (which may be set according to an actual distance, such as 3 m or 5 m), and may drag a teammate to the player's side through the carry skill. As shown in FIG. 17, the connecting line between the first virtual character and the second virtual character is displayed on the game screen.

In a possible implementation, the method further includes: displaying, in a case that the first virtual character is located on the second virtual item after jumping the target distance and the distance between the first virtual character and the second virtual character is greater than the preset distance threshold, the first virtual character located on the second virtual item, and skipping displaying the connecting line between the first virtual character and the second virtual character, where the skipping displaying the connecting line is used for indicating that the second virtual character is not allowed to move onto the virtual item, on which the first virtual character is currently located, by releasing the first virtual skill.

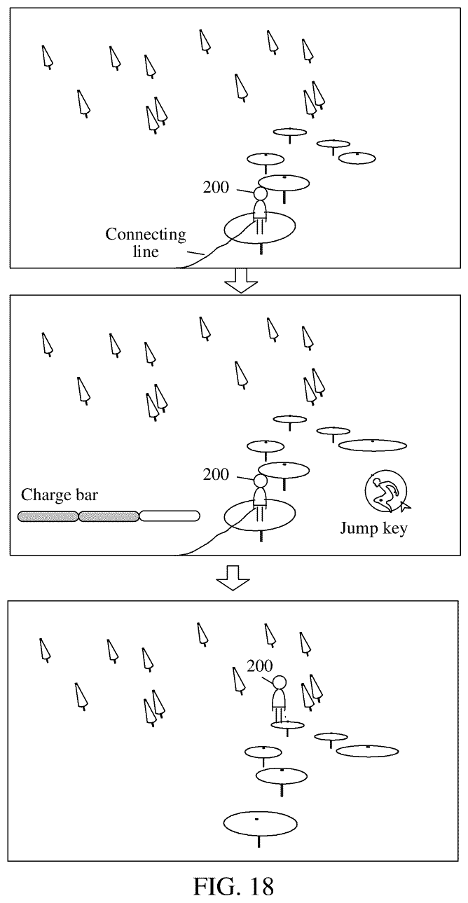

As an optional implementation, the carry skill may be used within a specified distance (less than or equal to the preset distance threshold, where the preset distance threshold may be set according to an actual distance, such as 5 m or 10 m), and if the distance is exceeded, the carry skill cannot be used. As shown in FIG. 18, after jumping the target distance, a first virtual character 108 jumps onto the second virtual item. If the distance between the first virtual character and the second virtual character is greater than the above preset distance threshold in this case, displaying the connecting line on the game screen is skipped, indicating that the first virtual character and the second virtual character are not allowed to use the carry skill. In other words, in this case, the first virtual character cannot use the carry skill to move the second virtual character onto the second virtual item.

In a possible implementation, after the releasing the first virtual skill to move the second virtual character onto the second virtual item, the method further includes: starting a countdown of the first virtual skill, where the first virtual skill is in a state of being prohibited from being released before the countdown ends.

As an optional implementation, the above carry skill has a cooling duration. The cooling duration may be set according to an actual situation, such as 5 s or 10 s. Within the cooling duration, the first virtual character and the second virtual character cannot use the carry skill. As shown in FIG. 17, after the first virtual character uses the carry skill, a countdown (10 s) is displayed on the game interface. The countdown starts from 10 s. Within the 10 s of the countdown, the first virtual character and the second virtual character cannot use the carry skill. After the countdown ends, a carry virtual key is displayed on the game interface, and the first virtual character and the second virtual character may continue to use the carry skill.

In a possible implementation, the method further includes: displaying, in a case that the first virtual character is not located on any virtual item in the group of virtual items after jumping the target distance and a second virtual skill is released, the first virtual character being moved onto the third virtual item on which the second virtual character is currently located, where the second virtual skill is a virtual skill allowed to be released by the second virtual character.

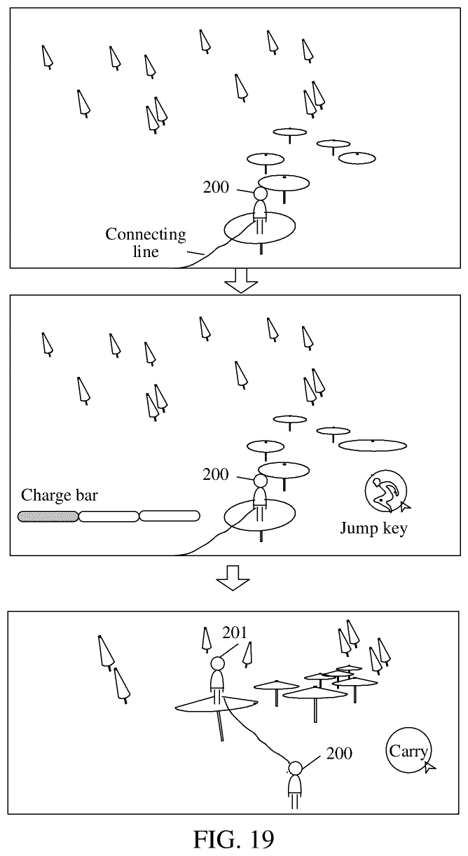

As an optional implementation, the above second virtual skill is the carry skill between the first virtual character and the second virtual character. As shown in FIG. 19, the first virtual character 200 is not located on any virtual item after jumping the target distance (the first virtual character falls, for example, to the ground or into the sea). If the carry skill between the first virtual character and the second virtual character is allowed to be released in this case, the first virtual character may be dragged, through the carry skill, to the virtual item on which the second virtual character is located. Specifically, the first virtual character may use the carry skill to drag itself to the item on which the second virtual character is located, or the second virtual character may use the carry skill to drag the first virtual character to the virtual item on which the second virtual character is located. In this embodiment, the second virtual skill also has a cooling duration. The cooling duration may be set according to an actual situation. Within the cooling duration, the first virtual character and the second virtual character cannot use the second virtual skill.

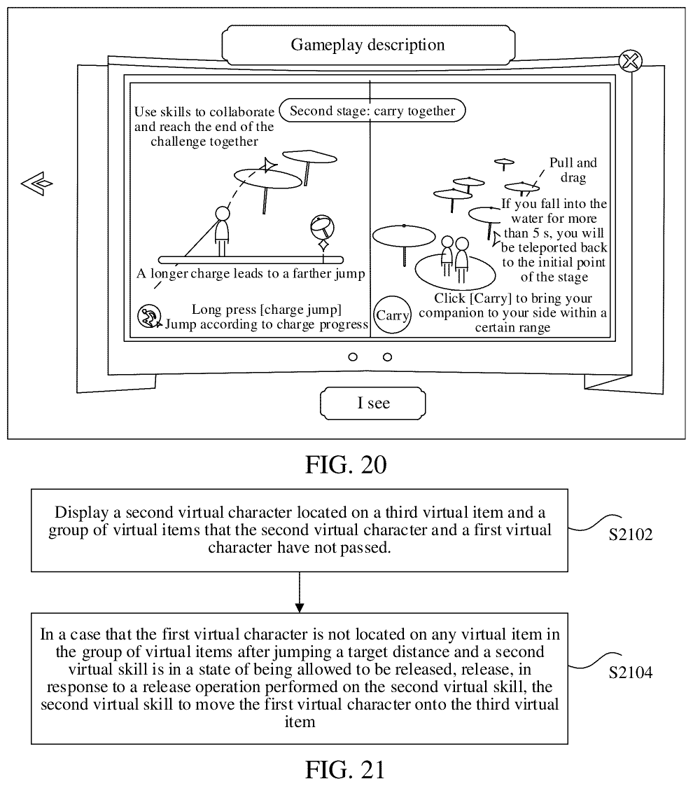

As an optional implementation, a gameplay description of the second stage is shown in FIG. 20. Through the gameplay description shown in the figure, the players may learn about a specific gameplay of Carry Together at the second stage.

According to another aspect of the aspects of this application, a virtual character control method is further provided. As shown in FIG. 21, the method includes the following steps:

S2102: Display a second virtual character located on a third virtual item and a group of virtual items that the second virtual character and a first virtual character have not passed.

S2104: In a case that the first virtual character is not located on any virtual item in the group of virtual items after jumping a target distance and a second virtual skill is in a state of being allowed to be released, release, in response to a release operation performed on the second virtual skill, the second virtual skill to move the first virtual character onto the third virtual item.

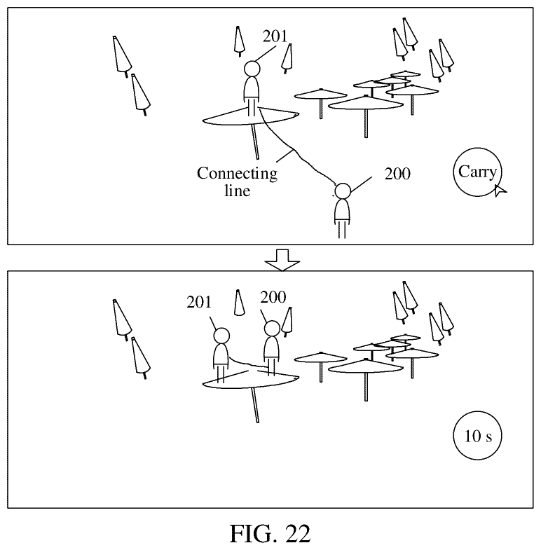

As an optional implementation, the above second virtual skill is the carry skill between the first virtual character and the second virtual character. When the second virtual character is located on the third virtual item, the first virtual character is not located on the virtual item after jumping the target distance (the first virtual character falls, e.g., falls to the ground or falls into the sea). If the second virtual skill is allowed to be released (the second virtual skill has a cooling duration, and is not allowed to be released within the cooling duration) as shown in FIG. 22, the player controlling the second virtual character may pull up the first virtual character to a side of the second virtual character by clicking on the carry virtual key, and at the same time, the carry skill enters a cooling time and a countdown starts.

In a possible implementation, the method further includes: displaying, in a case that the first virtual character is not located on any virtual item in the group of virtual items after jumping the target distance, a connecting line between the first virtual character and the second virtual character, where the connecting line is used for indicating that the first virtual character is allowed to move onto a virtual item, where the second virtual character is currently located, by releasing the second virtual skill.

As an optional implementation, as shown in FIG. 22, a connecting line is displayed between the first virtual character and the second virtual character. The connecting line is used for indicating that there is a carry skill between the first virtual character and the second virtual character. The first virtual character and the second virtual character may use the carry skill.

In a possible implementation, the method further includes: displaying, before the first virtual character jumps the target distance, the connecting line between the first virtual character and the second virtual character, where the connecting line is used for indicating that the second virtual character is allowed to move onto a virtual item, on which the first virtual character is currently located, by releasing the first virtual skill; displaying, in a case that the first virtual character is located on a second virtual item in the group of virtual items after jumping the target distance and a distance between the first virtual character and the second virtual character is less than or equal to a preset distance threshold, the first virtual character located on the second virtual item, the second virtual character located on the third virtual item, and the connecting line between the first virtual character and the second virtual character; and displaying, in a case that the first virtual character is located on the second virtual item after jumping the target distance and the distance between the first virtual character and the second virtual character is greater than the preset distance threshold, the first virtual character located on the second virtual item and the second virtual character located on the third virtual item, and skipping displaying the connecting line between the first virtual character and the second virtual character, where the skipping displaying the connecting line is used for indicating that the second virtual character is not allowed to move onto the virtual item, on which the first virtual character is currently located, by releasing the first virtual skill.

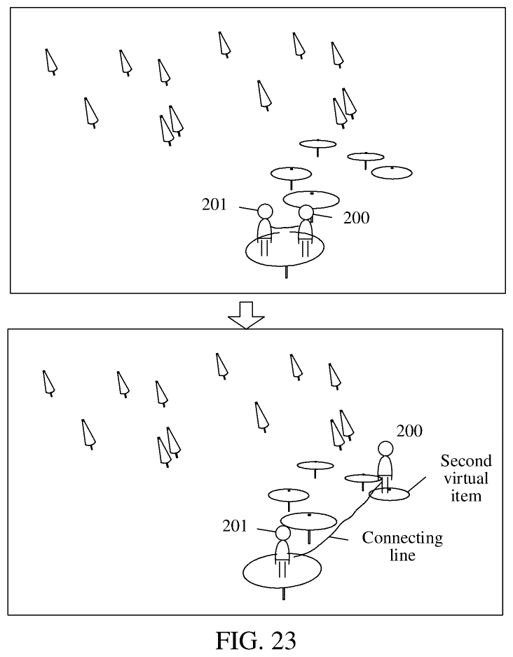

As an optional implementation, as shown in FIG. 23, in a case that the first virtual character and the second virtual character are located on a same virtual item (assuming that both are located on the third virtual item), the first virtual character and the second virtual character being located on the same virtual item and a connecting line between the first virtual character and the second virtual character are displayed on a game screen of the player controlling the second virtual character. The connecting line indicates that there is a carry skill between the first virtual character and the second virtual character.

After performing a charge jump action, the first virtual character jumps the target distance and then falls on the second virtual item. In this case, if the distance between the first virtual character and the second virtual character is less than or equal to the preset distance threshold (which may be determined according to an actual situation, e.g., 5 m or 10 m) in this case, the second virtual character being located on the third virtual item, the first virtual character being located on the second virtual item, and a connecting line between the first virtual character and the second virtual character are displayed on the game screen. The connecting line indicates that there is a carry skill between the first virtual character and the second virtual character.

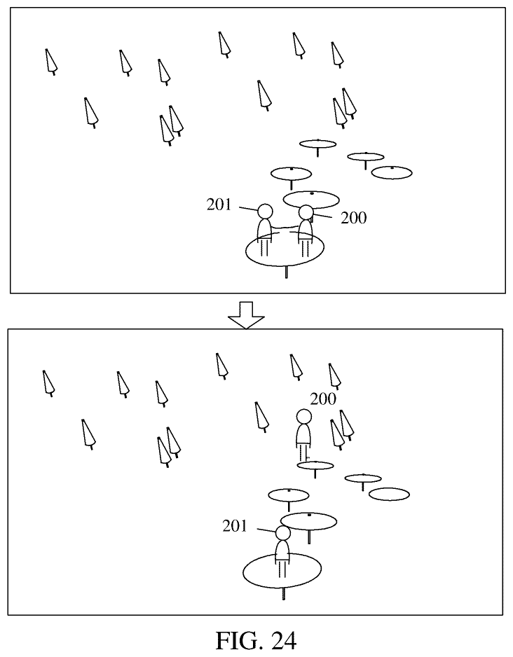

In another optional implementation, after performing a charge jump action, the first virtual character jumps the target distance and then falls on the second virtual item. In this case, if the distance between the first virtual character and the second virtual character is greater than the above preset distance threshold in this case, displaying a connecting line between the first virtual character and the second virtual character on the game screen is skipped, as shown in FIG. 24, which indicates that there is no carry skill between the first virtual character and the second virtual character.

In a possible implementation, after the skipping displaying the connecting line between the first virtual character and the second virtual character, the method further includes: controlling, in response to a jump triggering operation performed on the second virtual character, the second virtual character to jump a current distance; and displaying, in a case that the second virtual character is located on a fourth virtual item in the group of virtual items after jumping the current distance and the distance between the first virtual character and the second virtual character is less than or equal to the preset distance threshold, the first virtual character located on the second virtual item, the second virtual character located on the fourth virtual item, and the connecting line between the first virtual character and the second virtual character.

As an optional implementation, if there is no connecting line between the first virtual character and the second virtual character, it indicates that there is no carry skill between the first virtual character and the second virtual character. In this case, the first virtual character and the second virtual character need to perform a charge jump action respectively. If the distance between the first virtual character and the second virtual character is restored to be within the preset distance threshold, the connecting line between the first virtual character and the second virtual character is restored, indicating that the carry skill between the first virtual character and the second virtual character is restored.

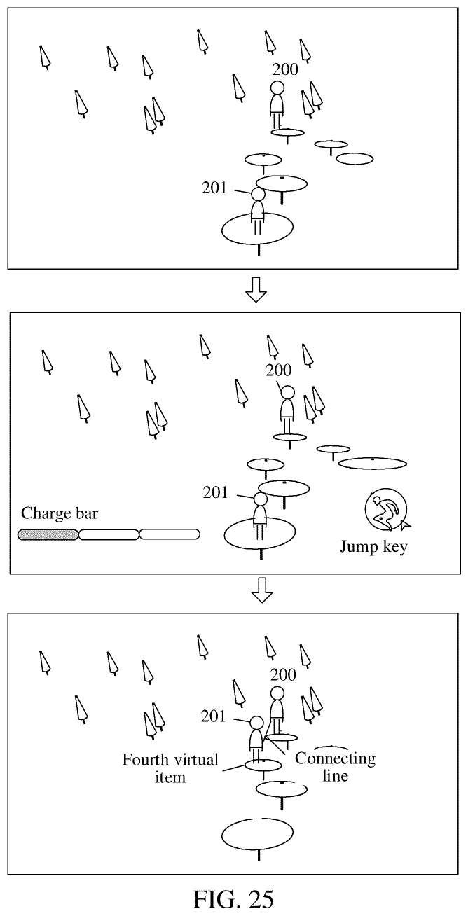

In a possible implementation, the current distance is positively related to a charge duration of the jump triggering operation. As an optional implementation, as shown in FIG. 25, the player controlling the second virtual character may touch the jump key to trigger the second virtual character to perform a charge jump action. The charge jump in this embodiment is the same as that in the above aspects. A longer triggering time indicates a greater charge and a farther jump. It is assumed that, as shown in FIG. 25, the second virtual character performs a charge jump action and then moves the current distance and falls on the fourth virtual item. In this case, if a distance between the first virtual character and the second virtual character is less than or equal to the above preset distance threshold, displaying the connecting line between the first virtual character and the second virtual character is restored, indicating that the carry skill between the first virtual character and the second virtual character is restored.

In a possible implementation, after the releasing the second virtual skill to move the first virtual character onto the third virtual item, the method further includes: starting a countdown of the second virtual skill, where the second virtual skill is in a state of being prohibited from being released before the countdown ends.

As an optional implementation, the carry skill between the first virtual character and the second virtual character has a cooling duration, which may be determined according to an actual situation, for example, 10 s. As shown in FIG. 22, after the carry skill is used, a countdown is displayed on the game screen. The countdown is used for indicating a countdown of the carry skill. Before the countdown ends, the carry skill is disabled. After the countdown ends, the carry skill can be used.

As an optional implementation, if a duration during which the first virtual character or the second virtual character falls on a virtual item exceeds a preset duration threshold (which may be determined according to an actual situation, e.g., 5 s), the initial position of the game at the second stage is returned.

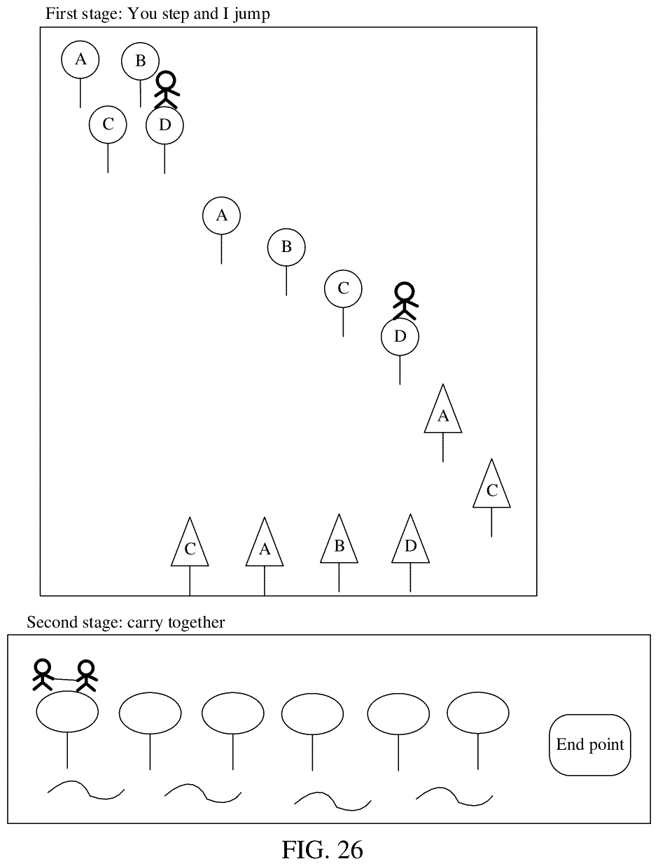

As an optional implementation, in the above aspects, the first stage is You step and I jump, and the second stage is Carry together. A game with the two stages may be used as a complete game. FIG. 26 shows a description of a game at two stages. Virtual items at the first stage each may accommodate a virtual character, and the virtual items are in a plurality of colors and have open and closed states. A gameplay page of the game is entered. Other skills of the virtual characters are shielded, and a single-section jump skill is assigned. The second virtual character moves in a group of virtual regions, and corresponding virtual items are opened. The first virtual character jumps on the virtual items. The virtual items that have been stepped on remain in the open state, and the player controlling the second virtual character needs to be notified, through voice or text by the player controlling the first virtual character, of the virtual items that have not been stepped on, to open the corresponding virtual items. After the first virtual character reaches the end point, the second virtual character may leave the virtual region.

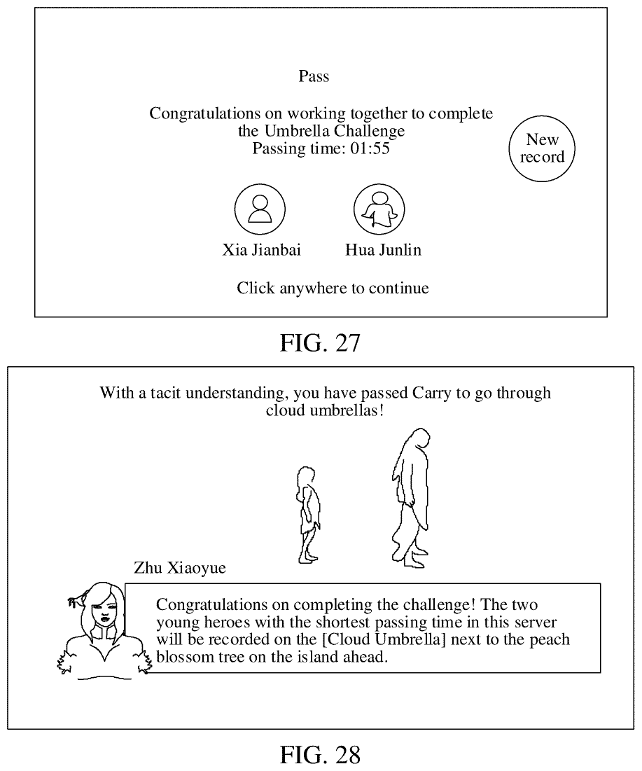

At the second stage, each of the virtual items may accommodate two virtual characters (the first virtual character and the second virtual character), the virtual item may move left and right at a constant speed, and a distance between the virtual item and a sea surface is higher than a jumping height, which is the same as the longest distance of the connecting line between the first virtual character and the second virtual character. When the first virtual item at the second stage is reached, the game at the second stage is started, the first virtual character and the second virtual character are connected (concentrically knotted), and the first virtual character and the second virtual character have a long-press charge jump skill and a carry skill. The long-press charge jump skill is related to a duration during which the player long presses the jump key. A longer duration indicates a greater charge and a farther jump. For the carry skill, when one of the first virtual character and the second virtual character falls from one virtual item, the virtual character falling may be pulled back to the other virtual character through the carry skill. The carry skill has a cooling duration. When both the first virtual character and the second virtual character fall from one virtual item, the challenge fails. If the first virtual character and the second virtual character reach the end point from the starting point, the challenge is successful. After the first virtual character and the second virtual character pass the game, a game screen shown in FIG. 27 is displayed. The first virtual character, the second virtual character, and a game-passing time of the first virtual character and the second virtual character are displayed on the game screen. In addition, after the first virtual character and the second virtual character pass the game, a game screen shown in FIG. 28 is displayed. A special game scene, such as falling rainbow (rainbow+petal rain), may also be displayed on the game screen. Drops of a special weather, i.e., rainbow fragments, may be collected. After 20 weather drops are collected, a weather box may be synthesized, and the weather may be triggered in a home.

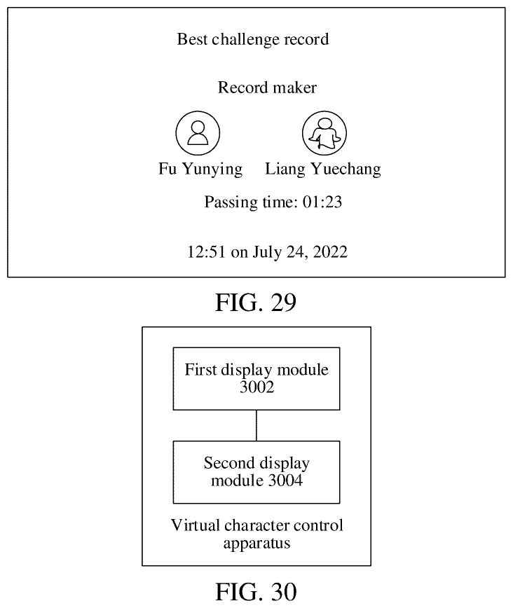

There is a ranking object in an end region. An interface may be opened by interaction. Two players with the shortest time in this server or across servers may be viewed. (If the times are consistent, the latest refresher information may be taken) (Only the first one is displayed). A common character avatar is displayed. A list of common functions may be clicked to pop up. A completion duration and a completion date of the two players are displayed. Refer to FIG. 29. If a record is refreshed, a new record stamp may be displayed on a score settlement page.

This solution is how to realize a two-player social jump level gameplay in a game. A specific implementation process is as follows:

A player A and a player B team up and use an NPC dialog option to trigger a server to start a two-player gameplay, and a client pops up a confirmation preparation interface to the two players. After the client detects that the two players confirm the preparation, the server initiates a two-player teleportation, and a gameplay plane is entered. After the gameplay plane is entered, the server detects whether the players are talking to an NPC and select a timing start option. Upon detection of a message, the client displays a countdown of 10 s. After the countdown ends, a timer component is displayed, and the server starts the timing officially. The server detects whether the second virtual character enters a virtual region, and if yes, opens the virtual item corresponding to the virtual region.

The server detects whether the virtual item has been stepped on by the first virtual character, and the client of the virtual item that has been stepped on remains open. The server detects whether any virtual character falls from the virtual items. If so, the client prompts entering the game. After 5 s, the virtual character is teleported back to the starting point. Then, a teleportation interface is called to teleport the virtual character back to an initial point of a level.

The server detects whether the virtual character enters the end of the first stage. If yes, the client displays a prompt indicating that the first stage is completed, a full-screen mask panel to enter the second stage is expanded, the server teleports both the first virtual character and the second virtual character to the starting point of the second stage, and the client expands a timer panel at the second stage and displays tips on how to use skills at the second stage.

The server continues to detect whether any virtual character falls from the virtual items. If so, after 5 s, the virtual character is teleported back to the starting point. Then, the teleportation interface is called to teleport the falling virtual character back to an initial point of a level at the second stage.

When the virtual character uses the charge jump skill, the client calls a corresponding jump action based on a charge duration, and the server calculates a real server position of the virtual character according to distance corresponding to the charge duration and a direction of the virtual character.

When the virtual character uses the carry skill, the server teleports a position of the other virtual character to a position of the virtual character using the skill, and the client plays a pulling process action.

When the server detects that the first virtual character and the second virtual character reach a range of the ending point, it is deemed that the level is completed, and a passing duration of the two players is uploaded. The client pops up a settlement interface and switches a weather atmosphere and a time for passing. The server brushes out collected objects at a specified configuration position. The server determines whether the passing duration is the shortest in this server. If so, a server-wide notification is triggered to notify the entire server that the two characters have refreshed the rankings, and the client refreshes and displays information of the two players on a scoreboard interactive interface.

In the above aspects, the method carries fun gameplay of a social ice-breaking function, which is low in difficulty and high in fun and randomness, and has fun of repeated experience. Cross-server players may alternatively team up to participate in the game together. Moreover, a score board object disposed at the ending point may show other players information of the player who has passed the level fastest in this server, achieving asynchronous socialization and satisfying psychology of showing off. The method plays an important role in cross-server social gameplays.

For brief description, the above method aspects are expressed as a series of action combinations. However, it is to be appreciated by a person skilled in the art that this application is not limited to the described order of the actions, because according to this application, some steps may be performed in other orders or simultaneously. In addition, a person skilled in the art also knows that all the aspects described in the specification are preferred aspects, and the related actions and modules are not necessarily mandatory to this application.

According to another aspect of the aspects of this application, a virtual character control apparatus configured to implement the above virtual character control method is further provided. As shown in FIG. 30, the apparatus includes: a first display module 3002 configured to display, in response to a second virtual character being located in a first virtual region of a group of virtual regions, a first virtual item in an open state, a first virtual character located on the first virtual item, and a group of virtual items that the first virtual character has not passed, where each virtual region in the group of virtual regions is used for controlling a type of virtual items to be in the open state, and in response to the second virtual character being located in the first virtual region, virtual items of a first type in the group of virtual items are in the open state, and virtual items of a first remaining type in the group of virtual items are in a closed state, the first remaining type being a type other than the first type in types to which the group of virtual items belongs; and a second display module 3004 configured to display, in response to the second virtual character moving from the first virtual region to a second virtual region in the group of virtual regions, virtual items of a second type in the group of virtual items being in the open state, and display virtual items of a second remaining type in the group of virtual items being in the closed state, where the second remaining type is a type other than the second type in the types to which the group of virtual items belongs, the virtual items in the open state are allowed to be passed by the first virtual character, and the virtual items in the closed state are prohibited from being passed by the first virtual character.

In a possible implementation, the apparatus is further configured to display, in response to the second virtual character moving from the first virtual region to the second virtual region, the first virtual character on the first virtual item in the open state, where a type of the first virtual item is the first type, and the virtual items that the first virtual character has passed are all in the open state, or the virtual item that the first virtual character finally passes is in the open state; or control, in response to the second virtual character moving from the first virtual region to the second virtual region, the first virtual item to switch from the open state to the closed state, where the type of the first virtual item is the first type.

In a possible implementation, the apparatus is further configured to, during the switching of the first virtual item from the open state to the closed state, in a case that it is detected that a jump triggering operation is performed on the first virtual character, control, in response to the jump triggering operation, the first virtual character to jump away from the first virtual item, where the jump triggering operation is used for controlling the first virtual character to jump away from the first virtual item.

In a possible implementation, the apparatus is further configured to, during the switching of the first virtual item from the open state to the closed state, in a case that it is not detected that the jump triggering operation is performed on the first virtual character, display the first virtual character falling from the first virtual item.

In a possible implementation, the apparatus is further configured to, in a case that the second virtual character is located in the second virtual region, the first virtual character is currently located on the first virtual item, and a type of a second virtual item allowed to be passed by the first virtual character and following the first virtual item is the second type, control, in response to the jump triggering operation performed on the first virtual character, the first virtual character to jump from the first virtual item to the second virtual item in the open state.

In a possible implementation, after the displaying of a first virtual item in an open state, a first virtual character located on the first virtual item, and a group of virtual items that the first virtual character has not passed, the apparatus is further configured to, in a case that the second virtual character is located in the first virtual region, the first virtual character is currently located on the first virtual item, and a type of a third virtual item allowed to be passed by the first virtual character and following the first virtual item is the first type, control, in response to the jump triggering operation performed on the first virtual character, the first virtual character to jump from the first virtual item to the third virtual item in the open state.

In a possible implementation, the apparatus is further configured to display, in a case that the first virtual character is located on the first virtual item in the open state, the second virtual character being located in the first virtual region in the group of virtual regions, where, in a case that the second virtual character is located in the first virtual region, the virtual items of the first type that the first virtual character has not passed are in the open state, and the virtual items of the first remaining type in the group of virtual items are in the closed state; and control, in response to a movement triggering operation performed on the second virtual character, the second virtual character to move from the first virtual region to the second virtual region, where, in a case that the second virtual character is located in the second virtual region, the virtual items of the second type are in the open state, and the virtual items of the second remaining type are in the closed state, where the virtual items in the open state are allowed to be passed by the first virtual character, and the virtual items in the closed state are prohibited from being passed by the first virtual character.

According to another aspect of the aspects of this application, a virtual character control apparatus is further provided. The apparatus includes: a third display module configured to display a first virtual character located on a first virtual item and a group of virtual items that the first virtual character and a second virtual character have not passed; a control module configured to control, in response to a jump triggering operation on the first virtual character, the first virtual character to jump a target distance, where the target distance is positively related to a charge duration of the jump triggering operation; and a first response module configured to, in a case that the first virtual character is located on a second virtual item in the group of virtual items after jumping the target distance and a first virtual skill is in a state of being allowed to be released, release, in response to a release operation performed on the first virtual skill, the first virtual skill to move the second virtual character onto the second virtual item.

In a possible implementation, the apparatus is further configured to display, before the controlling of the first virtual character to jump a target distance, a connecting line between the first virtual character and the second virtual character, where the connecting line is used for indicating that the second virtual character is allowed to move onto a virtual item, on which the first virtual character is currently located, by releasing the first virtual skill; and display, in a case that the first virtual character is located on the second virtual item after jumping the target distance and a distance between the first virtual character and the second virtual character is less than or equal to a preset distance threshold, the first virtual character located on the second virtual item, and displaying the connecting line between the first virtual character and the second virtual character.

In a possible implementation, the apparatus is further configured to display, in a case that the first virtual character is located on the second virtual item after jumping the target distance and the distance between the first virtual character and the second virtual character is greater than the preset distance threshold, the first virtual character located on the second virtual item, and skip displaying the connecting line between the first virtual character and the second virtual character, where the skipping displaying the connecting line is used for indicating that the second virtual character is not allowed to move onto the virtual item, on which the first virtual character is currently located, by releasing the first virtual skill.

In a possible implementation, after the releasing of the first virtual skill to move the second virtual character onto the second virtual item, the apparatus is further configured to start a countdown of the first virtual skill, where the first virtual skill is in a state of being prohibited from being released before the countdown ends.

In a possible implementation, the apparatus is further configured to display, in a case that the first virtual character is not located on any virtual item in the group of virtual items after jumping the target distance and a second virtual skill is released, the first virtual character being moved onto the third virtual item on which the second virtual character is currently located, where the second virtual skill is a virtual skill allowed to be released by the second virtual character.

According to another aspect, a virtual character control apparatus is further provided, including: a fourth display module configured to display a second virtual character located on a third virtual item and a group of virtual items that the second virtual character and a first virtual character have not passed; and in a case that the first virtual character is not located on any virtual item in the group of virtual items after jumping a target distance and a second virtual skill is in a state of being allowed to be released, release, in response to a release operation performed on the second virtual skill, the second virtual skill to move the first virtual character onto the third virtual item.

In a possible implementation, the apparatus is further configured to display, in a case that the first virtual character is not located on any virtual item in the group of virtual items after jumping the target distance, a connecting line between the first virtual character and the second virtual character, where the connecting line is used for indicating that the first virtual character is allowed to move onto a virtual item, where the second virtual character is currently located, by releasing the second virtual skill.

In a possible implementation, the apparatus is further configured to display, before the first virtual character jumps the target distance, the connecting line between the first virtual character and the second virtual character, where the connecting line is used for indicating that the second virtual character is allowed to move onto a virtual item, on which the first virtual character is currently located, by releasing the first virtual skill; display, in a case that the first virtual character is located on a second virtual item in the group of virtual items after jumping the target distance and a distance between the first virtual character and the second virtual character is less than or equal to a preset distance threshold, the first virtual character located on the second virtual item, the second virtual character located on the third virtual item, and the connecting line between the first virtual character and the second virtual character; and display, in a case that the first virtual character is located on the second virtual item after jumping the target distance and the distance between the first virtual character and the second virtual character is greater than the preset distance threshold, the first virtual character located on the second virtual item and the second virtual character located on the third virtual item, and skipping displaying the connecting line between the first virtual character and the second virtual character, where the skipping displaying the connecting line is used for indicating that the second virtual character is not allowed to move onto the virtual item, on which the first virtual character is currently located, by releasing the first virtual skill.

In a possible implementation, after the skipping displaying of the connecting line between the first virtual character and the second virtual character, the apparatus is further configured to control, in response to a jump triggering operation performed on the second virtual character, the second virtual character to jump a current distance; and display, in a case that the second virtual character is located on a fourth virtual item in the group of virtual items after jumping the current distance and the distance between the first virtual character and the second virtual character is less than or equal to the preset distance threshold, the first virtual character located on the second virtual item, the second virtual character located on the fourth virtual item, and the connecting line between the first virtual character and the second virtual character.

In a possible implementation, after the releasing of the second virtual skill to move the first virtual character onto the third virtual item, the apparatus is further configured to start a countdown of the second virtual skill, where the second virtual skill is in a state of being prohibited from being released before the countdown ends.

According to an aspect of this application, a computer program product is provided. The computer program product includes a computer program. The computer program includes program code used for performing the methods shown in the flowcharts. In such an aspect, by using a communication part 3109, the computer program may be downloaded and installed from a network, and/or installed from a removable medium 3111. When the computer program is executed by a central processing unit (CPU) 3101, the various functions provided in the aspects of this application are executed.

The sequence numbers of the above aspects of this application are merely for illustrative purposes, and are not intended to indicate priorities of the aspects.

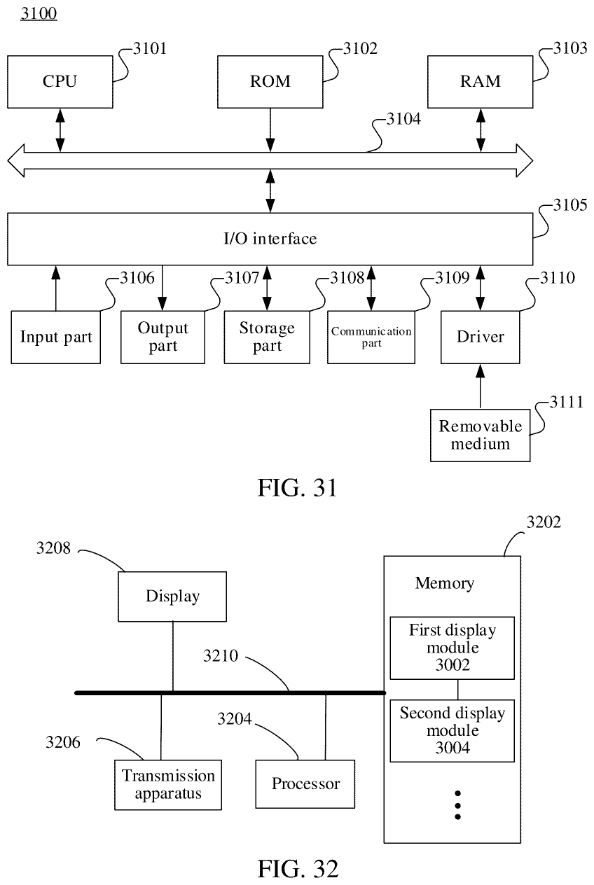

FIG. 31 schematically shows a structural block diagram of a computer system configured to implement an electronic device according to an embodiment of this application.

A computer system 3100 of the electronic device shown in FIG. 31 is merely an example, and does not constitute any limitation on functions and use ranges of the aspects of this application.

As shown in FIG. 31, the computer system 3100 includes the CPU 3101, which may perform various suitable actions and processing based on a program stored in a read-only memory (ROM) 3102 or a program loaded from a storage part 3108 into a random access memory (RAM) 3103. The RAM 3103 further stores various programs and data required for system operations. The CPU 3101, the ROM 3102, and the RAM 3103 are connected to each other through a bus 3104. An input/output (I/O) interface 3105 is also connected to the bus 3104.

The following components are connected to the I/O interface 3105: an input part 3106 including a keyboard, a mouse, or the like, an output part 3107 including a cathode ray tube (CRT), a liquid crystal display (LCD), a speaker, or the like, a storage part 3108 including a hard disk, or the like, and a communication part 3109 including a network interface card such as a local area network card or a modem. The communication part 3109 performs communication processing by using a network such as the Internet. A driver 3110 is also connected to the I/O interface 3105 as required. The removable medium 3111 such as a magnetic disk, an optical disc, a magneto-optical disk, or a semiconductor memory is installed on the driver 3110 as required, so that a computer program read therefrom is installed into the storage part 3108 as required.

Particularly, according to an aspect of this application, the processes described in the various method flowcharts may be implemented as computer software programs. For example, an aspect of this application includes a computer program product which includes a computer program carried on a computer-readable medium. The computer program includes program code used for performing the methods shown in the flowcharts. In such an aspect, by using the communication part 3109, the computer program may be downloaded and installed from a network, and/or installed from the removable medium 3111. When the computer program is executed by the CPU 3101, the various functions defined in the system of this application are executed.

According to another aspect, an electronic device configured to implement the above virtual character control method is further provided. The electronic device may be the terminal device or server shown in FIG. 1. In this aspect, the description is based on an example in which the electronic device is the terminal device. As shown in FIG. 32, the electronic device includes a memory 3202 and a processor 3204. The memory 3202 stores a computer program. The processor 3204 is configured to perform steps in any one of the above method aspects by using the computer program.

In a possible implementation, in this aspect, the above electronic device may be located in at least one of a plurality of network devices in a computer network.

In a possible implementation, a person of ordinary skill in the art may understand that, the structure shown in FIG. 32 is only illustrative. The electronic device may be a terminal device such as a smartphone (such as an Android mobile phone or an iOS mobile phone), a tablet computer, a palmtop computer, a mobile Internet device (MID), or a PAD. FIG. 32 does not constitute a limitation on a structure of the above electronic device. For example, the electronic device may further include more or fewer components (such as a network interface) than those shown in FIG. 32, or has a configuration different from that shown in FIG. 32.

The memory 3202 may be configured to store a software program and module, for example, program instructions/modules corresponding to the virtual character control method and apparatus in the aspects of this application. The processor 3204 runs the software program and module stored in the memory 3202, to implement various functional applications and data processing, that is, implement the above virtual character control method. The memory 3202 may include a high-speed random access memory, and may further include a non-volatile memory, for example, one or more magnetic storage apparatuses, a flash memory, or another non-volatile solid-state memory. In some examples, the memory 3202 may further include memories disposed remotely relative to the processor 3204, and the remote memories may be connected to the terminal through a network. Examples of the network include, but are not limited to, the Internet, an intranet, a local area network, a mobile communications network, and a combination thereof. The memory 3202 may be specifically, but not limited to, configured to, store game data, including information such as the first virtual character, the second virtual character, the virtual regions, and the virtual items. As an example, as shown in FIG. 32, the above memory 3202 may include, but is not limited to, the first display module 3002 and the second display module 3004 in the above virtual character control apparatus. In addition, the above memory may further include, but is not limited to, other module units in the above virtual character control apparatus, which are not described in detail in this example.

In a possible implementation, a transmission apparatus 3206 is configured to receive or send data by using a network. Specific examples of the above network include a wired network and a wireless network. In an example, the transmission apparatus 3206 includes a network interface controller (NIC), which may be connected to another network device and router by using a cable, so as to communicate with the Internet or a local area network. In an example, the transmission apparatus 3206 is a radio frequency (RF) module, which communicates with the Internet in a wireless manner.

In addition, the above electronic device further includes: a display 3208 configured to display the above game screens; and a connection bus 3210 configured to connect various module components in the above electronic device.

In other aspects, the above terminal device or server may be a node in a distributed system. The distributed system may be a blockchain system. The blockchain system may be a distributed system formed by connecting a plurality of nodes through network communication. A peer to peer (P2P) network may be formed among the nodes, and a computing device in any form such as a server, a terminal or other electronic devices may become a node in the blockchain system by joining the P2P network.

According to an aspect of this application, a computer-readable storage medium is provided. The computer-readable storage medium stores computer executable instructions. A processor of a computer device reads the computer executable instruction from the computer-readable storage medium, and the processor executes the instructions, to cause the computer device to perform the virtual character control methods provided in the above various optional implementations.

In a possible implementation, in this aspect, a person of ordinary skill in the art may understand that all or part of the steps of the methods in the above aspects may be implemented by a program by instructing hardware relevant to a terminal device. The program may be stored in a computer-readable storage medium. The storage medium may include a flash drive, a ROM, a RAM, a magnetic disk, an optical disk, and so on.

The sequence numbers of the above aspects of this application are merely for illustrative purposes, and are not intended to indicate priorities of the aspects.

When the integrated unit in the above aspects is implemented in the form of a software functional unit and sold or used as an independent product, the integrated unit may be stored in the above computer-readable storage medium. Based on such an understanding, the technical solutions of this application essentially, or the part contributing to the related art, or all or some of the technical solutions may be implemented in the form of a software product. The computer software product is stored in a storage medium and includes several instructions used for instructing one or more computer devices (which may be a personal computer, a server, a network device, or the like) to perform all or some of the steps of the method described in the aspects of this application.

In the above aspects of this application, the descriptions of the aspects have respective focuses. For a part that is not described in detail in one embodiment, refer to the related descriptions in other aspects.

In the several aspects provided in this application, the disclosed client may be implemented in another manner. For example, the apparatus aspects described above are merely exemplary. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the units or modules may be implemented in electronic, mechanical, or other forms.

The units described as separate parts may or may not be physically separate, and parts displayed as units may or may not be physical units, may be located in one position, or may be distributed on a plurality of network units. Part of or all of the units may be selected according to actual needs to achieve the objectives of the solutions of the aspects.

In addition, functional units in the aspects of the present application may be integrated into one processing unit, or each of the units may exist alone physically, or two or more units are integrated into one unit. The integrated unit may be implemented in a form of hardware, or may be implemented in a form of a software function unit.

The above descriptions are merely exemplary implementations of this application, and a person of ordinary skill in the art may further make several improvements and modifications without departing from the principle of this application. These improvements and modifications are also considered within the scope of this application.

What is claimed is:

1. A computer implemented method comprising:
establishing a plurality of groups of virtual items in a virtual environment, wherein each virtual item has an open state and a closed state, wherein each virtual item is traversable by any virtual character when in the open state and each virtual item is not traversable by any virtual character when in the closed state, and wherein each virtual item is at a discrete location within an otherwise non-traversable area in the virtual environment;
establishing a plurality of control locations in the virtual environment, wherein each of the control locations corresponds to a different one of the groups of virtual items;
moving a first virtual character, responsive to received first user inputs, among the plurality of control locations in the virtual environment;
determining, as the first virtual character moves among the plurality of control locations, a current control location in which the first virtual character is located;
moving a second virtual character, responsive to received second user inputs, among the virtual items in the virtual environment; and
dynamically configuring virtual items to be in the open state and the closed stated based on the current locations of the first virtual character and the second virtual character.

2. The method of claim 1, wherein dynamically configuring further comprises:
configuring each virtual item traversed by the second virtual character to be in the open state.

3. The method of claim 1, wherein dynamically configuring comprises:
configuring each virtual item in the group of virtual items corresponding to the current control location to be in the open state; and
configuring remaining virtual items to be in the closed state.

4. The method of claim 1, further comprising updating the dynamic configuration of the virtual items when the first virtual character moves from a first control region to a second control region.

5. The method of claim 1, wherein the received second user input indicates a target distance for the second virtual character to jump, the method further comprising causing the second virtual character to jump the target distance within the virtual environment.

6. The method of claim 5, wherein when the second virtual character lands the jump on any virtual item in the open state, receiving third user input to activate a first virtual skill causing the first virtual character to move onto a same virtual item as the second virtual character.

7. The method of claim 6, wherein the first virtual skill is not available when the first virtual character is located within the non-traversable area and the first virtual character is not located on any virtual item.

8. The method of claim 6, further comprising:
selectively displaying a connecting line between the first virtual character and the second virtual character, based on whether the second virtual character meets a predefined condition of the first virtual skill.

9. The method of claim 8, wherein the predefined condition comprises the first virtual character and the second virtual character being located within a predefined distance of each other within the virtual environment.

10. The method of claim 5, wherein the target distance is based on a charge duration indicated in the received second user input.

11. The method of claim 10, further comprising:
causing the second virtual character to fall when the charge duration does not correspond to a distance between a virtual item on which the second virtual character is located and a second virtual item; and
rescuing the second virtual character when first user input is received within a predetermined amount of time indicating to save the second virtual character.

12. One or more computer readable media storing computer readable instructions which, when executed by a processor, configure a data processing system to perform a cooperative method comprising:
establishing a plurality of groups of virtual items in a virtual environment, wherein each virtual item has an open state and a closed state, wherein each virtual item is traversable by any virtual character when in the open state and each virtual item is not traversable by any virtual character when in the closed state, and wherein each virtual item is at a discrete location within an otherwise non-traversable area in the virtual environment;
establishing a plurality of control locations in the virtual environment, wherein each of the control locations corresponds to a different one of the groups of virtual items;
moving a first virtual character, responsive to received first user inputs, among the plurality of control locations in the virtual environment;
determining, as the first virtual character moves among the plurality of control locations, a current control location in which the first virtual character is located;
moving a second virtual character, responsive to received second user inputs, among the virtual items in the virtual environment; and
dynamically configuring virtual items to be in the open state and the closed stated based on the current locations of the first virtual character and the second virtual character.

13. The computer readable media of claim 12, wherein dynamically configuring comprises:
configuring each virtual item traversed by the second virtual character to be in the open state;
configuring each virtual item in the group of virtual items corresponding to the current control location to be in the open state; and
configuring remaining virtual items to be in the closed state.

14. The computer readable media of claim 12, further comprising updating the dynamic configuration of the virtual items when the first virtual character moves from a first control region to a second control region.

15. The computer readable media of claim 12, further comprising:
causing the second virtual character to jump a target distance within the virtual environment, wherein the target distance is based on a charge duration indicated in the received second user input;
causing the second virtual character to fall when the charge duration does not correspond to a distance between a virtual item on which the second virtual character is located and a second virtual item; and
rescuing the second virtual character when first user input is received within a predetermined amount of time indicating to save the second virtual character.

16. The computer readable media of claim 15, wherein when the second virtual character lands the jump on any virtual item in the open state, receiving third user input to activate a first virtual skill causing the first virtual character to move onto a same virtual item as the second virtual character.

17. The computer readable media of claim 16, wherein the first virtual skill is not available when the first virtual character is located within the non-traversable area and the first virtual character is not located on any virtual item.

18. The computer readable media of claim 16, further comprising:
selectively displaying a connecting line between the first virtual character and the second virtual character, based on whether the second virtual character meets a predefined condition of the first virtual skill.

19. The computer readable media of claim 18, wherein the predefined condition comprises the first virtual character and the second virtual character being located within a predefined distance of each other within the virtual environment.

20. A data processing system, comprising:
a processor; and
memory storing computer readable instructions which, when executed by the processor, configure the data processing system to perform a cooperative method comprising:
establishing a plurality of groups of virtual items in a virtual environment, wherein each virtual item has an open state and a closed state, wherein each virtual item is traversable by any virtual character when in the open state and each virtual item is not traversable by any virtual character when in the closed state, and wherein each virtual item is at a discrete location within an otherwise non-traversable area in the virtual environment;
establishing a plurality of control locations in the virtual environment, wherein each of the control locations corresponds to a different one of the groups of virtual items;
moving a first virtual character, responsive to received first user inputs, among the plurality of control locations in the virtual environment;
determining, as the first virtual character moves among the plurality of control locations, a current control location in which the first virtual character is located;
moving a second virtual character, responsive to received second user inputs, among the virtual items in the virtual environment; and
dynamically configuring, during a first game segment, virtual items to be in the open state and the closed stated based on the current locations of the first virtual character and the second virtual character by:
configuring each virtual item traversed by the second virtual character to be in the open state;
configuring each virtual item in the group of virtual items corresponding to the current control location to be in the open state; and
configuring remaining virtual items to be in the closed state, and
causing, during a second game segment, each virtual character to jump a target distance within the virtual environment, wherein the target distance is based on a charge duration indicated in the received respective user input.
